(19) United States
(12) Patent Application Publication
(10) Pub. No.: US 2026/0019545 A1
(43) Pub. Date: Jan. 15, 2026

(54) METHOD AND SYSTEM FOR PERFORMING FOVEATED IMAGE COMPRESSION BASED ON EYE GAZE

(71) Applicant: Magic Leap, Inc., Plantation, FL (US)

(72) Inventor: Edward Diaz, Hialeah, FL (US)

(73) Assignee: Magic Leap, Inc., Plantation, FL (US)

(21) Appl. No.: 19/332,513

(22) Filed: Sep. 18, 2025

Related U.S. Application Data
(63) Continuation of application No. PCT/US2024/020491, filed on Mar. 19, 2024.
(60) Provisional application No. 63/453,376, filed on Mar. 20, 2023.

(51) Int. Cl. H04N 13/117; H04N 13/139; H04N 13/161; H04N 13/344; H04N 13/383

(52) U.S. Cl. CPC H04N 13/117; H04N 13/139; H04N 13/161; H04N 13/344; H04N 13/383

(57) ABSTRACT

An augmented reality (AR) system includes a wearable device including: a frame, a projector coupled to the frame, a display optically coupled to the projector, and an eye tracking system. The AR system also includes a memory and a processor configured to: receive an eye gaze location from the eye tracking system, generate an image, and generate a foveation map based on the eye gaze location. The foveation map includes a first region of the image and a second region of the image. The processor is also configured to compress the first region of the image using a first quality setting and the second region of the image using a second quality setting. The first quality setting (e.g., a setting of 100%) can be greater than the second quality setting.

### CROSS-REFERENCES TO RELATED APPLICATIONS

This application is a continuation of International Patent Application No. PCT/US2024/020491, filed Mar. 19, 2024, entitled “METHOD AND SYSTEM FOR PERFORMING FOVEATED IMAGE COMPRESSION BASED ON EYE GAZE,” which claims the benefit of and priority to U.S. Provisional Patent Application No. 63/453,376, filed on Mar. 20, 2023, entitled “METHOD AND SYSTEM FOR PERFORMING FOVEATED IMAGE COMPRESSION BASED ON EYE GAZE,” the entire disclosures of which are hereby incorporated by reference, for all purposes, as if fully set forth herein.

### BACKGROUND OF THE INVENTION

Modern computing and display technologies have facilitated the development of systems for so-called virtual reality or augmented reality experiences, wherein digitally reproduced images or portions thereof are presented to a viewer in a manner wherein they seem to be, or may be perceived as, real. A virtual reality, or VR, scenario typically involves presentation of digital or virtual image information without transparency to other actual real-world visual input; an augmented reality, or AR, scenario typically involves presentation of digital or virtual image information as an augmentation to visualization of the actual world around the viewer.

Referring to FIG. 1, an augmented reality scene 100 is depicted. The user of an AR technology sees a real-world park-like setting featuring people, trees, buildings in the background, and a concrete platform 120. The user also perceives that he/she “sees” “virtual content” such as a robot statue 110 standing upon the real-world concrete platform 120, and a flying cartoon-like avatar character 102 which seems to be a personification of a bumble bee. These elements 110 and 102 are “virtual” in that they do not exist in the real world. Because the human visual perception system is complex, it is challenging to produce AR technology that facilitates a comfortable, natural-feeling, rich presentation of virtual image elements amongst other virtual or real-world imagery elements.

Despite the progress made in these display technologies, there is a need in the art for improved methods and systems related to augmented reality systems, particularly, display systems.

### SUMMARY OF THE INVENTION

The present invention relates generally to methods and systems related to projection display systems including wearable displays. More particularly, embodiments of the present invention provide methods and systems that combine the concept of foveation (i.e., reduced video quality at sections where the human eye is not focused) with the concept of compression. The invention is applicable to a variety of applications in computer vision and image display systems and light field projection systems, including stereoscopic systems, systems that deliver beamlets of light to the retina of the user, or the like.

Numerous benefits are achieved by way of the present invention over conventional techniques. For example, embodiments of the present invention provide methods and systems that enable portions of an image or video stream corresponding to the location of the eye gaze of the user to be compressed using a higher quality setting than portions of the image or video stream that are more distant from the location corresponding to the eye gaze of the user. Accordingly, memory and processing resources can be conserved while making a reduced or minimal impact on the user experience. These and other embodiments of the invention along with many of its advantages and features are described in more detail in conjunction with the text below and attached figures.

### BRIEF DESCRIPTION OF THE DRAWINGS

FIG. 1 illustrates a user's view of augmented reality (AR) through an AR device.

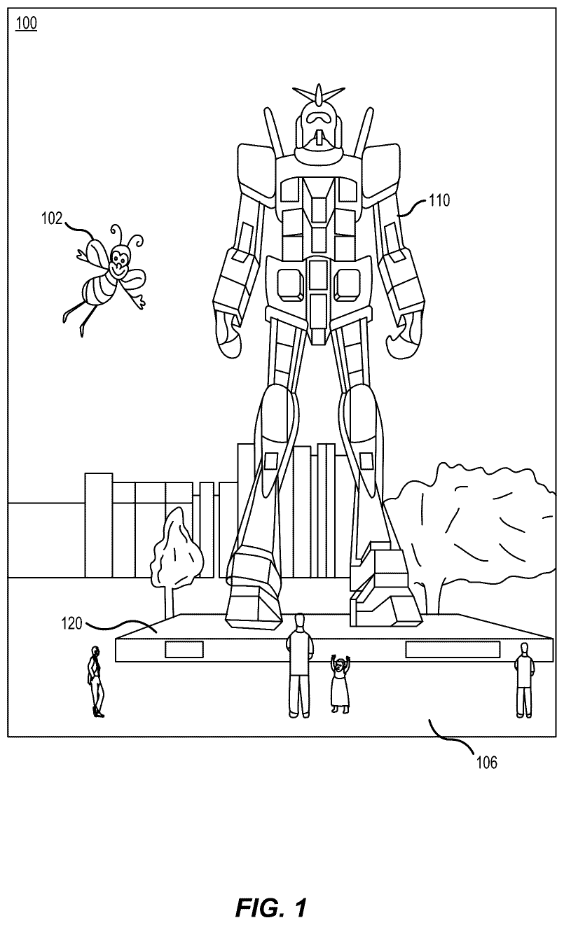

FIG. 2A illustrates a cross-sectional, side view of an example of a set of stacked waveguides that each includes an incoupling optical element.

FIG. 2B illustrates a perspective view of an example of the one or more stacked waveguides of FIG. 2A.

FIG. 2C illustrates a top-down, plan view of an example of the one or more stacked waveguides of FIGS. 2A and 2B.

FIG. 3 is a simplified illustration of an eyepiece waveguide having a combined pupil expander according to an embodiment of the present invention.

FIG. 4 illustrates an example of wearable display system according to an embodiment of the present invention.

FIG. 5 shows a perspective view of a wearable device according to an embodiment of the present invention.

FIG. 6 is a diagram illustrating run length encoding of a quantized DCT block according to an embodiment of the present invention.

FIG. 7 is a diagram illustrating a JPEG header structure.

FIG. 8 is a line drawing illustrating an image compressed using a single quality setting.

FIG. 9 is a line drawing illustrating a foveated image with three foveated regions according to an embodiment of the present invention.

FIG. 10 is a line drawing illustrating a foveated image with post-processing in the foveated regions according to another embodiment of the present invention.

FIG. 11 is a foveated 3D generated image with three foveated regions according to yet another embodiment of the present invention.

FIG. 12 is a line drawing illustrating an image that can be utilized in conjunction with multiple foveation maps according to an embodiment of the present invention.

FIG. 13 is a simplified flowchart illustrating a method of compressing an image according to an embodiment of the present invention.

FIG. 14 is a simplified schematic diagram illustrating a gaze-based image foveation system according to an embodiment of the present invention.

FIG. 15 illustrates a compression-level obtained as a function of time, represented by successive frames versus frequency, for both a sparsity compression system implementation and a DSC-SPARSE system implementation, according to an embodiment of the present invention.

FIG. 16 illustrates a histogram of frame count versus compression for a sparsity compression system implementation and a DSC-SPARSE system implementation according to an embodiment of the present invention.

FIG. 17 is a simplified flowchart illustrating a method of compressing image frames using an alternating compression algorithm according to an embodiment of the present invention.

FIG. 18 is a simplified image illustrating an image frame divided into a high quality region and a low quality region according to an embodiment of the present invention.

FIG. 19 is a simplified flowchart illustrating a method of compressing an image using different compression ratios for a high quality region and a low quality region, according to an embodiment of the present invention.

FIG. 20 is a simplified image illustrating an image frame divided into high quality tiles and low quality tiles according to an embodiment of the present invention.

FIG. 21 is a simplified flowchart illustrating a method of compressing an image using different compression ratios for high quality tiles and low quality tiles, according to an embodiment of the present invention.

FIG. 22 is a simplified block diagram illustrating components of an AR system according to an embodiment of the present invention.

### DETAILED DESCRIPTION OF SPECIFIC EMBODIMENTS

Reference will now be made to the drawings, in which like reference numerals refer to like parts throughout. Unless indicated otherwise, the drawings are schematic not necessarily drawn to scale.

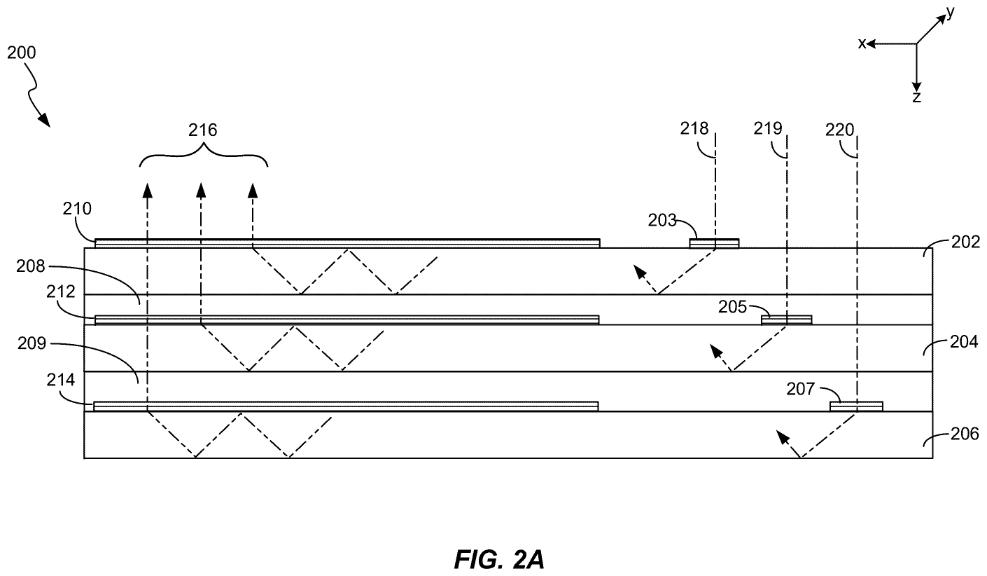

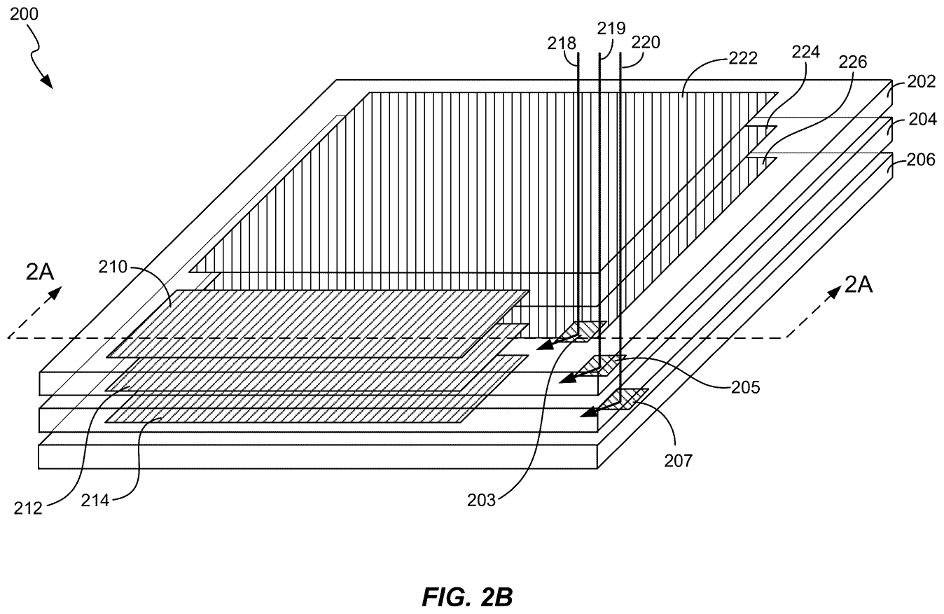

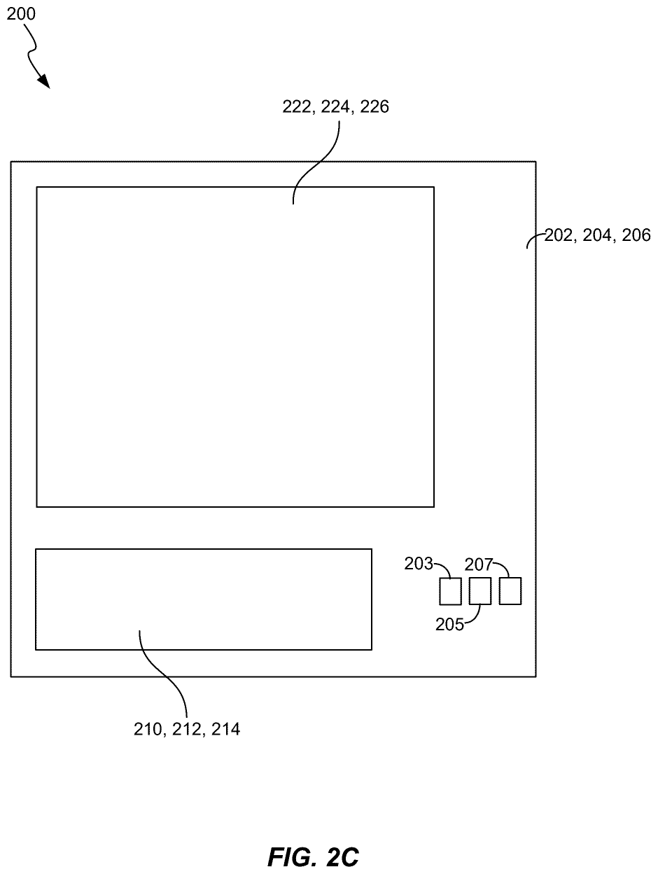

With reference now to FIG. 2A, in some embodiments, light impinging on a waveguide may need to be redirected to incouple that light into the waveguide. An incoupling optical element may be used to redirect and in-couple the light into its corresponding waveguide. Although referred to as “incoupling optical element” through the specification, the incoupling optical element need not be an optical element and may be a non-optical element. FIG. 2A illustrates a cross-sectional, side view of an example of a set 200 of stacked waveguides that each includes an incoupling optical element. The waveguides may each be configured to output light of one or more different wavelengths, or one or more different ranges of wavelengths. Light from a projector is injected into the set 200 of stacked waveguides and outcoupled to a user as described more fully below.

The illustrated set 200 of stacked waveguides includes waveguides 202, 204, and 206. Each waveguide includes an associated incoupling optical element (which may also be referred to as a light input area on the waveguide), with, e.g., incoupling optical element 203 disposed on a major surface (e.g., an upper major surface) of waveguide 202, incoupling optical element 205 disposed on a major surface (e.g., an upper major surface) of waveguide 204, and incoupling optical element 207 disposed on a major surface (e.g., an upper major surface) of waveguide 206. In some embodiments, one or more of the incoupling optical elements 203, 205, 207 may be disposed on the bottom major surface of the respective waveguides 202, 204, 206 (particularly where the one or more incoupling optical elements are reflective, deflecting optical elements). As illustrated, the incoupling optical elements 203, 205, 207 may be disposed on the upper major surface of their respective waveguide 202, 204, 206 (or the top of the next lower waveguide), particularly where those incoupling optical elements are transmissive, deflecting optical elements. In some embodiments, the incoupling optical elements 203, 205, 207 may be disposed in the body of the respective waveguide 202, 204, 206. In some embodiments, as discussed herein, the incoupling optical elements 203, 205, 207 are wavelength-selective, such that they selectively redirect one or more wavelengths of light, while transmitting other wavelengths of light. While illustrated on one side or corner of their respective waveguides 202, 204, 206, it will be appreciated that the incoupling optical elements 203, 205, 207 may be disposed in other areas of their respective waveguides 202, 204, 206 in some embodiments.

As illustrated, the incoupling optical elements 203, 205, 207 may be laterally offset from one another. In some embodiments, each incoupling optical element may be offset such that it receives light without that light passing through another incoupling optical element. For example, each incoupling optical element 203, 205, 207 may be configured to receive light from a different projector and may be separated (e.g., laterally spaced apart) from other incoupling optical elements 203, 205, 207 such that it substantially does not receive light from the other ones of the incoupling optical elements 203, 205, 207.

Each waveguide also includes associated light distributing elements, with, e.g., light distributing elements 210 disposed on a major surface (e.g., a top major surface) of waveguide 202, light distributing elements 212 disposed on a major surface (e.g., a top major surface) of waveguide 204, and light distributing elements 214 disposed on a major surface (e.g., a top major surface) of waveguide 206. In some other embodiments, the light distributing elements 210, 212, 214 may be disposed on a bottom major surface of associated waveguides 202, 204, 206, respectively. In some other embodiments, the light distributing elements 210, 212, 214 may be disposed on both top and bottom major surfaces of associated waveguides 202, 204, 206, respectively; or the light distributing elements 210, 212, 214 may be disposed on different ones of the top and bottom major surfaces in different associated waveguides 202, 204, 206, respectively.

The waveguides 202, 204, 206 may be spaced apart and separated by, e.g., gas, liquid, and/or solid layers of material. For example, as illustrated, layer 208 may separate waveguides 202 and 204; and layer 209 may separate waveguides 204 and 206. In some embodiments, the layers 208 and 209 are formed of low refractive index materials (that is, materials having a lower refractive index than the material forming the immediately adjacent one of waveguides 202, 204, 206). Preferably, the refractive index of the material forming the layers 208, 209 is 0.05 or more, or 0.10 or less than the refractive index of the material forming the waveguides 202, 204, 206. Advantageously, the lower refractive index layers 208, 209 may function as cladding layers that facilitate total internal reflection (TIR) of light through the waveguides 202, 204, 206 (e.g., TIR between the top and bottom major surfaces of each waveguide). In some embodiments, the layers 208, 209 are formed of air. While not illustrated, it will be appreciated that the top and bottom of the illustrated set 200 of waveguides may include immediately neighboring cladding layers.

Preferably, for case of manufacturing and other considerations, the material forming the waveguides 202, 204, 206 are similar or the same, and the material forming the layers 208, 209 are similar or the same. In some embodiments, the material forming the waveguides 202, 204, 206 may be different between one or more waveguides, and/or the material forming the layers 208, 209 may be different, while still holding to the various refractive index relationships noted above.

With continued reference to FIG. 2A, light rays 218, 219, 220 are incident on the set 200 of waveguides. It will be appreciated that the light rays 218, 219, 220 may be injected into the waveguides 202, 204, 206 by one or more projectors (not shown).

In some embodiments, the light rays 218, 219, 220 have different properties, e.g., different wavelengths or different ranges of wavelengths, which may correspond to different colors. The incoupling optical elements 203, 205, 207 each deflect the incident light such that the light propagates through a respective one of the waveguides 202, 204, 206 by TIR. In some embodiments, the incoupling optical elements 203, 205, 207 each selectively deflect one or more particular wavelengths of light, while transmitting other wavelengths to an underlying waveguide and associated incoupling optical element.

For example, incoupling optical element 203 may be configured to deflect ray 218, which has a first wavelength or range of wavelengths, while transmitting rays 219 and 220, which have different second and third wavelengths or ranges of wavelengths, respectively. The transmitted ray 219 impinges on and is deflected by the incoupling optical element 205, which is configured to deflect light of a second wavelength or range of wavelengths. The ray 220 is deflected by the incoupling optical element 207, which is configured to selectively deflect light of a third wavelength or range of wavelengths.

With continued reference to FIG. 2A, the deflected light rays 218, 219, 220 are deflected so that they propagate through a corresponding waveguide 202, 204, 206; that is, the incoupling optical elements 203, 205, 207 of each waveguide deflects light into that corresponding waveguide 202, 204, 206 to in-couple light into that corresponding waveguide. The light rays 218, 219, 220 are deflected at angles that cause the light to propagate through the respective waveguide 202, 204, 206 by TIR. The light rays 218, 219, 220 propagate through the respective waveguide 202, 204, 206 by TIR until impinging on the waveguide's corresponding light distributing elements 210, 212, 214, where they are outcoupled to provide out-coupled light rays 216.

With reference now to FIG. 2B, a perspective view of an example of the stacked waveguides of FIG. 2A is illustrated. As noted above, the in-coupled light rays 218, 219, 220, are deflected by the incoupling optical elements 203, 205, 207, respectively, and then propagate by TIR within the waveguides 202, 204, 206, respectively. The light rays 218, 219, 220 then impinge on the light distributing elements 210, 212, 214, respectively. The light distributing elements 210, 212, 214 deflect the light rays 218, 219, 220 so that they propagate towards the outcoupling optical elements 222, 224, 226, respectively.

In some embodiments, the light distributing elements 210, 212, 214 are orthogonal pupil expanders (OPEs). In some embodiments, the OPEs deflect or distribute light to the outcoupling optical elements 222, 224, 226 and, in some embodiments, may also increase the beam or spot size of this light as it propagates to the outcoupling optical elements. In some embodiments, the light distributing elements 210, 212, 214 may be omitted and the incoupling optical elements 203, 205, 207 may be configured to deflect light directly to the outcoupling optical elements 222, 224, 226. For example, with reference to FIG. 2A, the light distributing elements 210, 212, 214 may be replaced with outcoupling optical elements 222, 224, 226, respectively. In some embodiments, the outcoupling optical elements 222, 224, 226 are exit pupils (EPs) or exit pupil expanders (EPEs) that direct light to the eye of the user. It will be appreciated that the OPEs may be configured to increase the dimensions of the eye box in at least one axis and the EPEs may be configured to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EPE again, at which time another portion of the impinging light is directed out of the waveguide, and so on. Consequently, a single beam of in-coupled light may be “replicated” each time a portion of that light is redirected by an OPE or EPE, thereby forming a field of cloned beams of light. In some embodiments, the OPE and/or EPE may be configured to modify a size of the beams of light. In some embodiments, the functionality of the light distributing elements 210, 212, and 214 and the outcoupling optical elements 222, 224, 226 are combined in a combined pupil expander as discussed in relation to FIG. 2E.

Accordingly, with reference to FIGS. 2A and 2B, in some embodiments, the set 200 of waveguides includes waveguides 202, 204, 206; incoupling optical elements 203, 205, 207; light distributing elements (e.g., OPEs) 210, 212, 214; and outcoupling optical elements (e.g., EPs) 222, 224, 226 for each component color. The waveguides 202, 204, 206 may be stacked with an air gap/cladding layer between each one. The incoupling optical elements 203, 205, 207 redirect or deflect incident light (with different incoupling optical elements receiving light of different wavelengths) into its waveguide. The light then propagates at an angle which will result in TIR within the respective waveguide 202, 204, 206. In the example shown, light ray 218 (e.g., blue light) is deflected by the first incoupling optical element 203, and then continues to bounce down the waveguide, interacting with the light distributing element (e.g., OPEs) 210 and then the outcoupling optical element (e.g., EPs) 222, in a manner described earlier. The light rays 219 and 220 (e.g., green and red light, respectively) will pass through the waveguide 202, with light ray 219 impinging on and being deflected by incoupling optical element 205. The light ray 219 then bounces down the waveguide 204 via TIR, proceeding on to its light distributing element (e.g., OPEs) 212 and then the outcoupling optical element (e.g., EPs) 224. Finally, light ray 220 (e.g., red light) passes through the waveguide 206 to impinge on the light incoupling optical elements 207 of the waveguide 206. The light incoupling optical elements 207 deflect the light ray 220 such that the light ray propagates to light distributing element (e.g., OPEs) 214 by TIR, and then to the outcoupling optical element (e.g., EPs) 226 by TIR. The outcoupling optical element 226 then finally out-couples the light ray 220 to the viewer, who also receives the outcoupled light from the other waveguides 202, 204.

FIG. 2C illustrates a top-down, plan view of an example of the stacked waveguides of FIGS. 2A and 2B. As illustrated, the waveguides 202, 204, 206, along with each waveguide's associated light distributing element 210, 212, 214 and associated outcoupling optical element 222, 224, 226, may be vertically aligned. However, as discussed herein, the incoupling optical elements 203, 205, 207 are not vertically aligned; rather, the incoupling optical elements are preferably nonoverlapping (e.g., laterally spaced apart as seen in the top-down or plan view). As discussed further herein, this nonoverlapping spatial arrangement facilitates the injection of light from different resources into different waveguides on a one-to-one basis, thereby allowing a specific light source to be uniquely coupled to a specific waveguide. In some embodiments, arrangements including nonoverlapping spatially separated incoupling optical elements may be referred to as a shifted pupil system, and the incoupling optical elements within these arrangements may correspond to sub pupils.

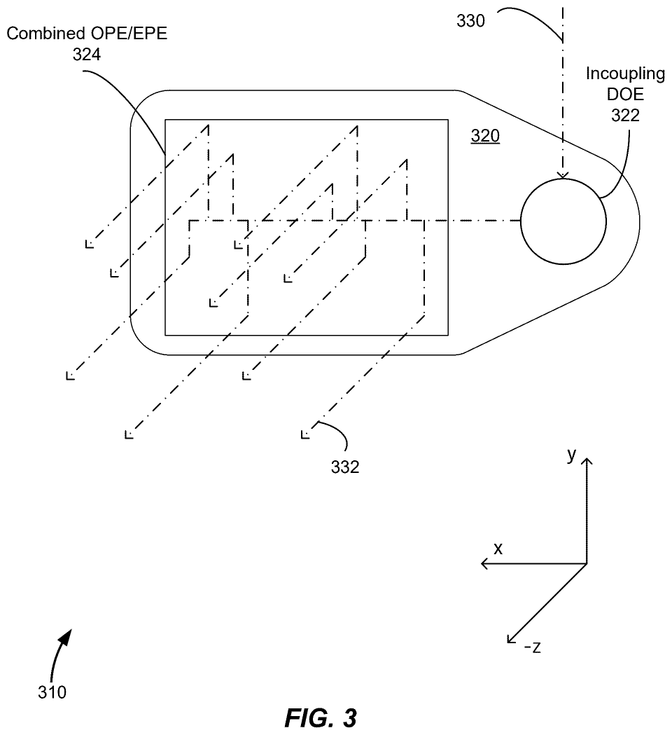

FIG. 3 is a simplified illustration of an eyepiece waveguide having a combined pupil expander according to an embodiment of the present invention. In the example illustrated in FIG. 3, the eyepiece 310 utilizes a combined OPE/EPE region in a single-side configuration. Referring to FIG. 3, the eyepiece 310 includes a substrate 320 in which in-coupling optical element 322 and a combined OPE/EPE region 324, also referred to as a combined pupil expander (CPE), are provided. Incident light ray 330 is incoupled via the incoupling optical element 320 and outcoupled as output light rays 332 via the combined OPE/EPE region 324.

The combined OPE/EPE region 324 includes gratings corresponding to both an OPE and an EPE that spatially overlap in the x-direction and the y-direction. In some embodiments, the gratings corresponding to both the OPE and the EPE are located on the same side of a substrate 320 such that either the OPE gratings are superimposed onto the EPE gratings or the EPE gratings are superimposed onto the OPE gratings (or both). In other embodiments, the OPE gratings are located on the opposite side of the substrate 320 from the EPE gratings such that the gratings spatially overlap in the x-direction and the y-direction but are separated from each other in the z-direction (i.e., in different planes). Thus, the combined OPE/EPE region 324 can be implemented in either a single-sided configuration or in a two-sided configuration.

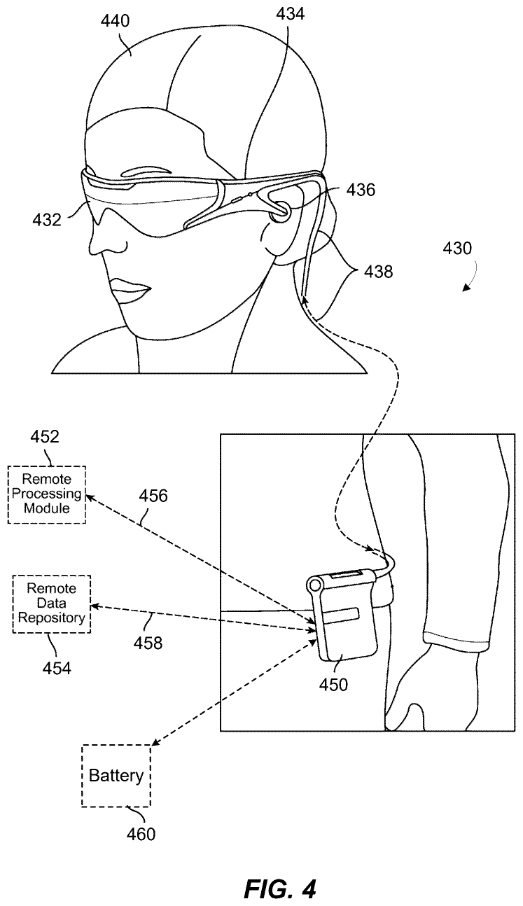

FIG. 4 illustrates an example of wearable display system 430 into which the various waveguides and related systems disclosed herein may be integrated. With reference to FIG. 4, the display system 430 includes a display 432, and various mechanical and electronic modules and systems to support the functioning of that display 432. The display 432 may be coupled to a frame 434, which is wearable by a display system user 440 (also referred to as a viewer) and which is configured to position the display 432 in front of the eyes of the user 440. The display 432 may be considered eyewear in some embodiments. In some embodiments, a speaker 436 is coupled to the frame 434 and configured to be positioned adjacent the car canal of the user 440 (in some embodiments, another speaker, not shown, may optionally be positioned adjacent the other ear canal of the user to provide stereo/shapeable sound control). The display system 430 may also include one or more microphones or other devices to detect sound. In some embodiments, the microphone is configured to allow the user to provide inputs or commands to the system 430 (e.g., the selection of voice menu commands, natural language questions, etc.), and/or may allow audio communication with other persons (e.g., with other users of similar display systems). The microphone may further be configured as a peripheral sensor to collect audio data (e.g., sounds from the user and/or environment). In some embodiments, the display system 430 may further include one or more outwardly directed environmental sensors configured to detect objects, stimuli, people, animals, locations, or other aspects of the world around the user. For example, environmental sensors may include one or more cameras, which may be located, for example, facing outward so as to capture images similar to at least a portion of an ordinary field of view of the user 440. In some embodiments, the display system may also include a peripheral sensor, which may be separate from the frame 434 and attached to the body of the user 440 (e.g., on the head, torso, an extremity, etc. of the user 440). The peripheral sensor may be configured to acquire data characterizing a physiological state of the user 440 in some embodiments. For example, the sensor may be an electrode.

The display 432 is operatively coupled by a communications link, such as by a wired lead or wireless connectivity, to a local data processing module which may be mounted in a variety of configurations, such as fixedly attached to the frame 434, fixedly attached to a helmet or hat worn by the user, embedded in headphones, or otherwise removably attached to the user 440 (e.g., in a backpack-style configuration, in a belt-coupling style configuration). Similarly, the sensor may be operatively coupled by a communications link, e.g., a wired lead or wireless connectivity, to the local processor and data module. The local processing and data module may comprise a hardware processor, as well as digital memory, such as non-volatile memory (e.g., flash memory or hard disk drives), both of which may be utilized to assist in the processing, caching, and storage of data. Optionally, the local processor and data module may include one or more central processing units (CPUs), graphics processing units (GPUs), dedicated processing hardware, and so on. The data may include data a) captured from sensors (which may be, e.g., operatively coupled to the frame 434 or otherwise attached to the user 440), such as image capture devices (such as cameras), microphones, inertial measurement units, accelerometers, compasses, GPS units, radio devices, gyros, and/or other sensors disclosed herein; and/or b) acquired and/or processed using remote processing module 452 and/or remote data repository 454 (including data relating to virtual content), possibly for passage to the display 432 after such processing or retrieval. The local processing and data module may be operatively coupled by communication links 438 such as via wired or wireless communication links, to the remote processing and data module 450, which can include the remote processing module 452, the remote data repository 454, and a battery 460. The remote processing module 452 and the remote data repository 454 can be coupled by communication links 456 and 458 to remote processing and data module 450 such that these remote modules are operatively coupled to each other and available as resources to the remote processing and data module 450. In some embodiments, the remote processing and data module 450 may include one or more of the image capture devices, microphones, inertial measurement units, accelerometers, compasses, GPS units, radio devices, and/or gyros. In some other embodiments, one or more of these sensors may be attached to the frame 434, or may be standalone structures that communicate with the remote processing and data module 450 by wired or wireless communication pathways.

With continued reference to FIG. 4, in some embodiments, the remote processing and data module 450 may comprise one or more processors configured to analyze and process data and/or image information, for instance including one or more central processing units (CPUs), graphics processing units (GPUs), dedicated processing hardware, and so on. In some embodiments, the remote data repository 454 may comprise a digital data storage facility, which may be available through the internet or other networking configuration in a “cloud” resource configuration. In some embodiments, the remote data repository 454 may include one or more remote servers, which provide information, e.g., information for generating augmented reality content, to the local processing and data module and/or the remote processing and data module 450. In some embodiments, all data is stored and all computations are performed in the local processing and data module, allowing fully autonomous use from a remote module. Optionally, an outside system (e.g., a system of one or more processors, one or more computers) that includes CPUs, GPUs, and so on, may perform at least a portion of processing (e.g., generating image information, processing data) and provide information to, and receive information from, the illustrated modules, for instance, via wireless or wired connections.

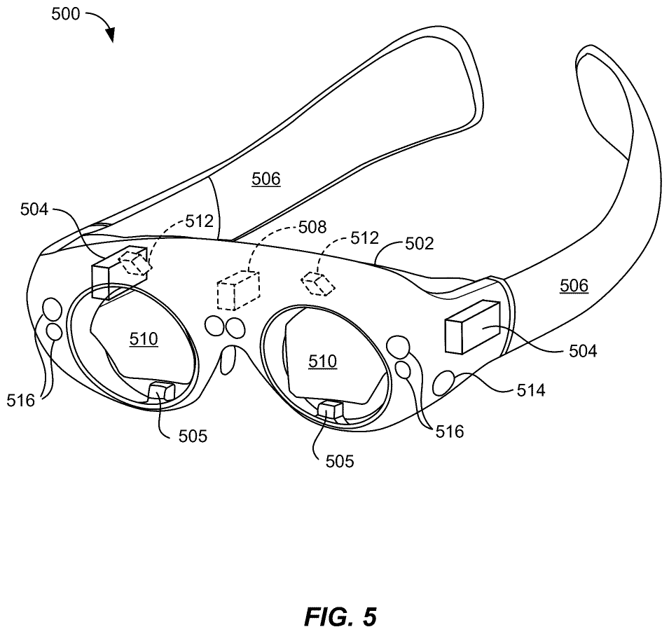

FIG. 5 shows a perspective view of a wearable device 500 according to an embodiment of the present invention. Wearable device 500 includes a frame 502 configured to support one or more projectors 504 at various positions along an interior-facing surface of frame 502, as illustrated. In some embodiments, projectors 504 can be attached at positions near temples 506. Alternatively, or in addition, another projector could be placed in position 508. Such projectors may, for instance, include or operate in conjunction with one or more liquid crystal on silicon (LCoS) modules, micro-LED displays, or fiber scanning devices. In some embodiments, light from projectors 504 or projectors disposed in positions 508 could be guided into eyepieces 510 for display to eyes of a user. Projectors placed at positions 512 can be somewhat smaller on account of the close proximity this gives the projectors to the waveguide system. The closer proximity can reduce the amount of light lost as the waveguide system guides light from the projectors to eyepiece 510. In some embodiments, the projectors at positions 512 can be utilized in conjunction with projectors 504 or projectors disposed in positions 508. While not depicted, in some embodiments, projectors could also be located at positions beneath eyepieces 510. Wearable device 500 is also depicted including sensors 514 and 516. Sensors 514 and 516 can take the form of forward-facing and lateral-facing optical sensors configured to characterize the real-world environment surrounding wearable device 500.

Embodiments of the present invention utilize an eye tracking system to determine the eye gaze location of the user and utilize the eye gaze location for image compression processes. Referring to FIG. 5, eye tracking cameras 505 are located on the frame 502 and can be utilized to track the eye gaze location of the user using the wearable device 500. In other embodiments, other eye tracking systems are utilized to determine the eye gaze location and the eye tracking cameras 505 illustrated in FIG. 5 are merely exemplary. As described more fully herein, the image compression processes utilized to compress and decompress virtual content for storage in memory, internal communications, and display, among other functions, can be modified depending on the eye gaze location, for example, portions of an image or video stream corresponding to the eye gaze location can be compressed using a higher quality compression process compared to other portions of the image or video stream that are located more distant from the eye gaze location. Since these more distant portions of the image or video stream are in the user's peripheral vision, any impact on the user experience resulting from the reduction in compression quality can be less than the benefits achieved in terms of memory and processing efficiency and/or requirements. One of ordinary skill in the art would recognize many variations, modifications, and alternatives.

In conventional systems, image compression (e.g., JPEG compression) is implemented at a fixed quality for the image or video stream that does not take into account the human gaze. Since MPEG is a derivative of JPEG, embodiments of the present invention are applicable to MPEG compression processes as appropriate. By knowing where the human gaze is currently located and taking the human gaze into account, embodiments of the present invention can reduce the quality (i.e., the bandwidth) at locations in an image where the user is not looking, i.e., locations in the image that are spatially separated from the eye gaze location, thereby decreasing the image quality in these regions and decreasing the overall need to send something at a superior quality setting that the human eye would not be able to discern, because the human eye is not currently focused on these non-gaze locations. Thus, embodiments of the present invention provide a video compression algorithm that takes human gaze into account and creates a foveated compression algorithm dependent on human gaze.

In some embodiments, the JPEG algorithm receives an image and segments it into macro-blocks (e.g., 16 pixels×16 pixels). These macro-blocks are then subjected to a discrete cosine transform (DCT) process. The DCT process generates a set of coefficients, which are filtered so that the high frequency values are eliminated (this is where the quality step resides). After this process occurs, the block is then run length encoded.

### Encoder Based Foveation Map

Table 1 is a matrix illustrating an 8×8 pixel sub-image block according to an embodiment of the present invention. The 8×8 pixel sub-image block can also be referred to as a macro-block or a tile. The 8×8 pixels are represented by the pixel values illustrated in the matrix.

TABLE 1

| | | | | | | | |
|---|---|---|---|---|---|---|---|
| 52 | 55 | 61 | 66 | 70 | 61 | 64 | 73 |
| 63 | 59 | 55 | 90 | 109 | 85 | 69 | 72 |
| 62 | 59 | 68 | 113 | 144 | 104 | 66 | 73 |
| 63 | 58 | 71 | 122 | 154 | 106 | 70 | 69 |
| 67 | 61 | 68 | 104 | 126 | 88 | 68 | 70 |
| 79 | 65 | 60 | 70 | 77 | 68 | 58 | 75 |
| 85 | 71 | 64 | 59 | 55 | 61 | 65 | 83 |
| 87 | 79 | 69 | 68 | 65 | 76 | 78 | 94 |

Table 2 is a matrix illustrating an example of an encoded 8×8 FDCT block according to an embodiment of the present invention. In conventional systems, JPEG/MPEG compressions process a whole image at a fixed quality. The process of filtering results in the generation of the zero data illustrated in the quantized DCT block illustrated in Table 3. This filter occurs with a given quality setting. As illustrated in Table 2, the magnitude of values generally decreases from the upper left portion of the matrix to the lower right portion of the matrix.

TABLE 2

| | | | | | | | |
|---|---|---|---|---|---|---|---|
| −415 | −30 | −61 | 27 | 56 | −20 | −2 | 0 |
| 4 | −22 | −61 | 10 | 13 | −7 | −9 | 5 |
| −47 | 7 | 77 | −25 | −29 | 10 | 5 | −6 |
| −49 | 12 | 34 | −15 | −10 | 6 | 2 | 2 |
| 12 | −7 | −13 | −4 | −2 | 2 | −3 | 3 |
| −8 | 3 | 2 | −6 | −2 | 1 | 4 | 2 |
| −1 | 0 | 0 | −2 | −1 | −3 | 4 | −1 |
| 0 | 0 | −1 | −4 | −1 | 0 | 1 | 2 |

Table 3 is a matrix illustrating an example of a quantized DCT block according to an embodiment of the present invention. In Table 3, quantization results in a significant number of the values being reduced to zero.

TABLE 3

| | | | | | | | |
|---|---|---|---|---|---|---|---|
| −26 | −3 | −6 | 2 | 2 | −1 | 0 | 0 |
| 0 | −2 | −4 | 1 | 1 | 0 | 0 | 0 |
| −3 | 1 | 5 | −1 | −1 | 0 | 0 | 0 |
| −4 | 1 | 2 | −1 | 0 | 0 | 0 | 0 |
| 1 | 0 | 0 | 0 | 0 | 0 | 0 | 0 |
| 0 | 0 | 0 | 0 | 0 | 0 | 0 | 0 |
| 0 | 0 | 0 | 0 | 0 | 0 | 0 | 0 |
| 0 | 0 | 0 | 0 | 0 | 0 | 0 | 0 |

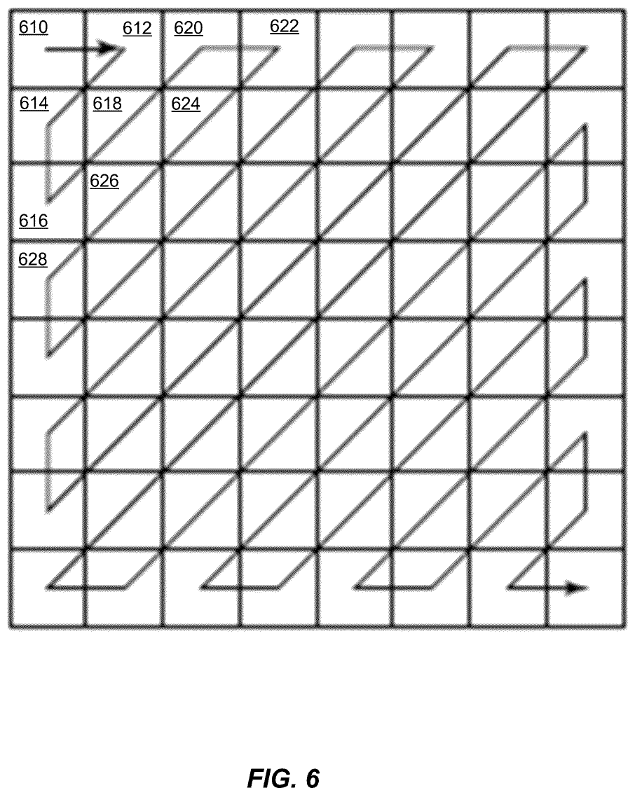

FIG. 6 is a diagram illustrating run length encoding of a quantized DCT block according to an embodiment of the present invention. In order to encode the quantized DCT block, a run length encoding process starts at the upper left pixel and progresses to the lower right pixel. Referring to FIG. 6, pixel 610 is encoded, followed by the encoding of pixel 612. Next, encoding progresses to the next two rows of pixels, resulting in the encoding of pixel 614 and pixel 616. Subsequent encoding processes result in the encoding of pixels 618, 620, and 622. At this stage, the encoding process reverses direction, encoding pixels 624, 626, and 628.

This pattern of encoding is then continued until all of the pixels in the block have been encoded.

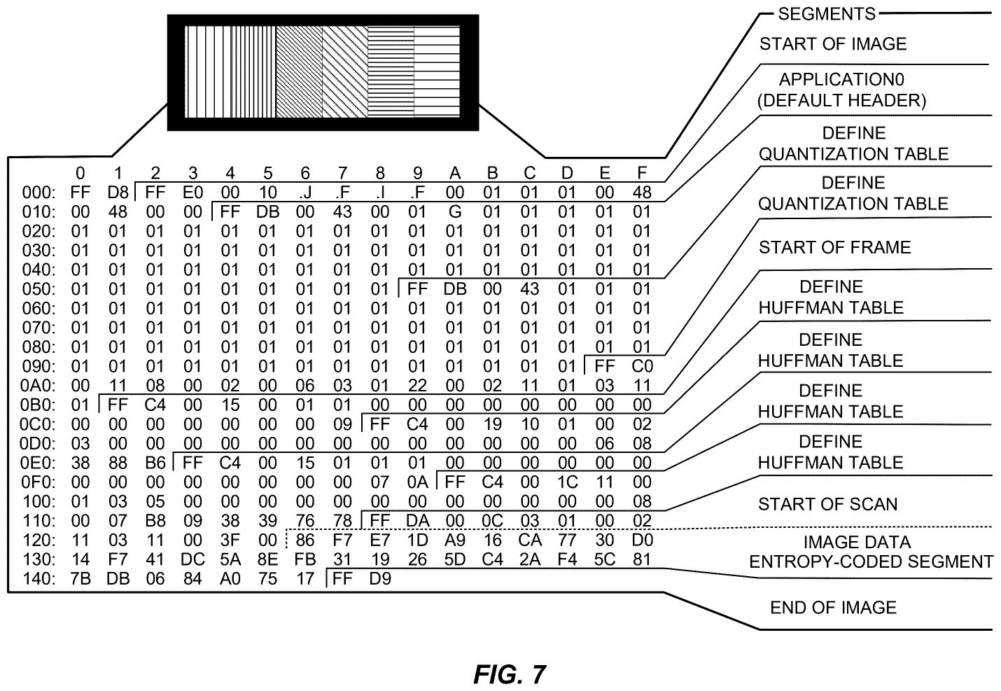

FIG. 7 is a diagram illustrating a JPEG header structure. As illustrated in FIG. 7, in the JPEG header structure, the default quality for the entire image is stored in the quantization table map area. Thus, a single quality setting is used to compress the entire image. As described herein, the quantization table can apply to the unfoveated region(s), providing a 100% quality setting for regions corresponding to the location of the eye gaze, or the quantization table can apply to the regions more distance from the location of the eye gaze, providing a reduced quality setting for the foveated region. One of ordinary skill in the art would recognize many variations, modifications, and alternatives.

Referring to FIG. 7, the Segments include Start of Image, Application0 (Default Header), Define Quantization Table (for luminance), Defined Quantization Table (for chrominance), Start of Frame, Define Huffman Table 1, Define Huffman Table 2, Define Huffman Table 3, Define Huffman Table 4, Start of Scan, Image Data (entropy-coded segment), and End of Image. The Fields and Values for these Segments are shown in Table 4.

TABLE 4

| SEGMENTS | FIELDS | VALUES |
|---|---|---|
| APPLICATION0 | Marker/length | FFE0/16 |
| (DEFAULT HEADER) | | |
| | Identifier | JFIF\0 |
| | Version | 1.1 |
| | Units | 1 (dpi) |
| | Density | 72 × 72 |
| | thumbnail | 0 × 0 |
| DEFINE | Marker/length | FFDB/67 |
| QUANTIZATION TABLE | | |
| | Destination | 0 (luminance) |
| | Table (8 × 8) | {1} (100% quality) |
| DEFINE | Marker/length | FFDB/67 |
| QUANTIZATION TABLE | | |
| | Destination | 1 (chrominance) |
| | Table (8 × 8) | {1} (100% quality) |
| START OF FRAME | Marker/length | FFCO/17 |
| | Precision | 8 |
| | Line Nb | 2 |
| | Samples/line | 6 |
| | Components | 3 |
| | Id factor table | 1 1 × 1 0 (LumY) |
| | Id factor table | 2 2 × 2 1 (ChromCb) |
| | Id factor table | 3 2 × 2 1 (ChromCr) |
| DEFINE | Marker/length | FFC4/21 |
| HUFFMAN TABLE 1 | | |
| | Class | 0 (DC) |
| | Destination | 0 |
| | 1 code of 1 bit 00 | |
| | 1 code of 2 bits 09 | |
| DEFINE | Marker/length | FFC4/25 |
| HUFFMAN TABLE 2 | | |
| | Class | 0 (DC) |
| | Destination | 0 |
| | 1 code of 1 bit 00 | |
| | 2 code of 3 bits 06 08 | |
| | 3 code of 4 bits 38 88 B6 | |
| DEFINE | Marker/length | FFC4/21 |
| HUFFMAN TABLE 3 | | |
| | Class | 0 (DC) |
| | Destination | 1 |
| | 1 code of 1 bit 07 | |
| | 1 code of 2 bits 0A | |
| DEFINE | Marker/length | FFC4/28 |
| HUFFMAN TABLE 4 | | |
| | Class | 1 (AC) |
| | Destination | 1 |
| | 1 code of 1 bit 08 | |
| | 3 code of 3 bits 00 07 B8 | |
| | 5 code of 4 bits 09 38 39 76 78 | |
| START OF SCAN | Marker/Length | FFDA/12 |
| | Components | 3 |
| | Selector/DC, | |
| | AC table | |
| | 1/0, 0 | |
| | 2/1, 1 | |
| | 3/1, 1 | |
| | Spectral select. 0 . . . 63 | |
| | Successive approx. 00 | |
| IMAGE DATA | 86F7E71DA916CA7730D014 | |
| ENTROPY-CODED | F741DC5A8EFB3119265DC4 | |
| SEGMENT | 2AF45C817BDB0684A07517 | |
| END OF IMAGE | Marker | FFD9 |

Embodiments of the present invention maintain high quality on the blocks that the eye is focused on while reducing the quality setting on the blocks of the image that the eye is not focused on. These different quality settings are stored in a foveation map. Therefore, a foveation map can be passed to the compression engine. In turn, the compression engine can selectively alter predetermined video blocks corresponding to the eye gaze location in order to compress these predetermined video blocks with high quality, while other blocks can be compressed with low quality.

The foveation map can be created based on eye gaze information, namely, by being able to actively tell where the human eye is currently focused or looking. In embodiments of the present invention, the foveation map is supplied to the encoder and passed to the decoder.

An added benefit provided by embodiments of that present invention is that, by using the concept of video blocks, the blocks with zero data (i.e., that are all black) will consume reduced memory space or power during the video display process. Thus, embodiments of the present invention utilize a video block compression algorithm that is modified to implement a variable quality per block.

### Decoder Based Foveation Map

The decoder can use the current stream of DCT coefficients, which are included as part of the compression standard, that were passed to it. Therefore, some blocks would have more coefficients and some blocks would have fewer coefficients. However, the foveation map can be sent or passed along to the decoder so that the decoder will be able to use the locations of the reduced quality blocks/tile locations. Thus, the foveation map is used by the decoder to apply the desired quality setting to each tile/block. Additionally, this information can be used in order to apply a post processing image filtration in order to remove JPEG low quality artifacts.

### Map Implementation

It should be noted that a particular implementation could have an inferred 100% quality and utilize the global table as the alternate table, or vice versa. Embodiments of the present invention can utilize a variety of mechanisms for implementing the quality map selection. As described herein, embodiments utilize more than one quality setting per image, with the quality setting being defined on a per tile/block basis. Thus, the foveation map that is supplied to the encoder (e.g., a JPEG encoder) enables the encoder to determine which quality setting is used for a given tile/block.

Instead of two maps, three or more maps can be used as well. The foveation index (0,1,2 . . . ) per block would indicate to the encoder which map to implement. Therefore, we can have ranges with 100%, 75%, 50%, 25% quality settings, or the like.

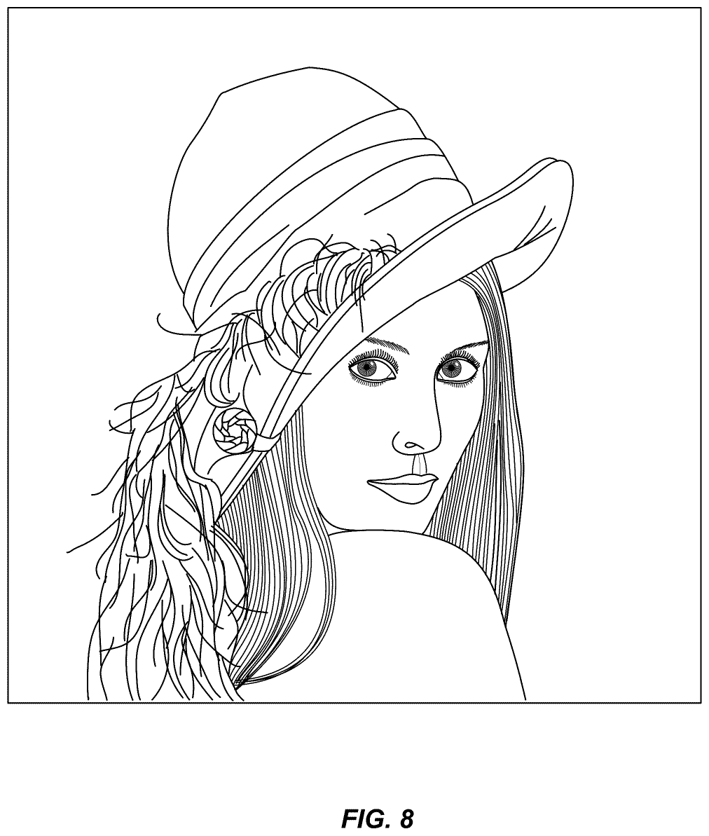

FIG. 8 is a line drawing illustrating an image compressed using a single quality setting. In this case, all of the pixels in the image are compressed using a conventional process that utilizes a single quality setting for the pixels. Although this process achieves uniform image compression across the image, the inventors have determined that processing and memory requirements can be reduced if portions of the image that are distant from the location where the user is looking are compressed with reduced quality compared to the portion of the image corresponding to the location where the user is looking while still achieving a desired user experience.

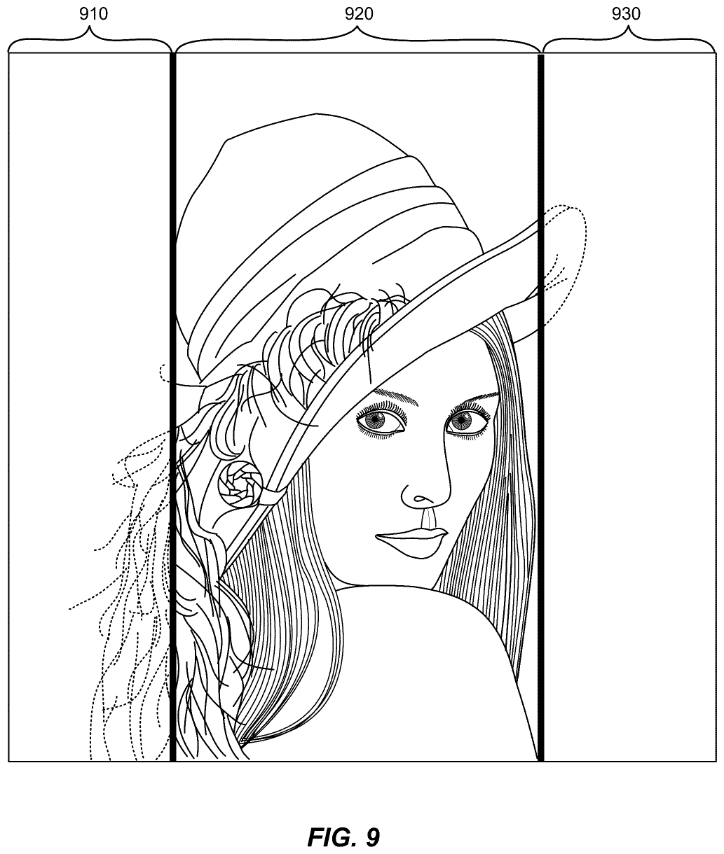

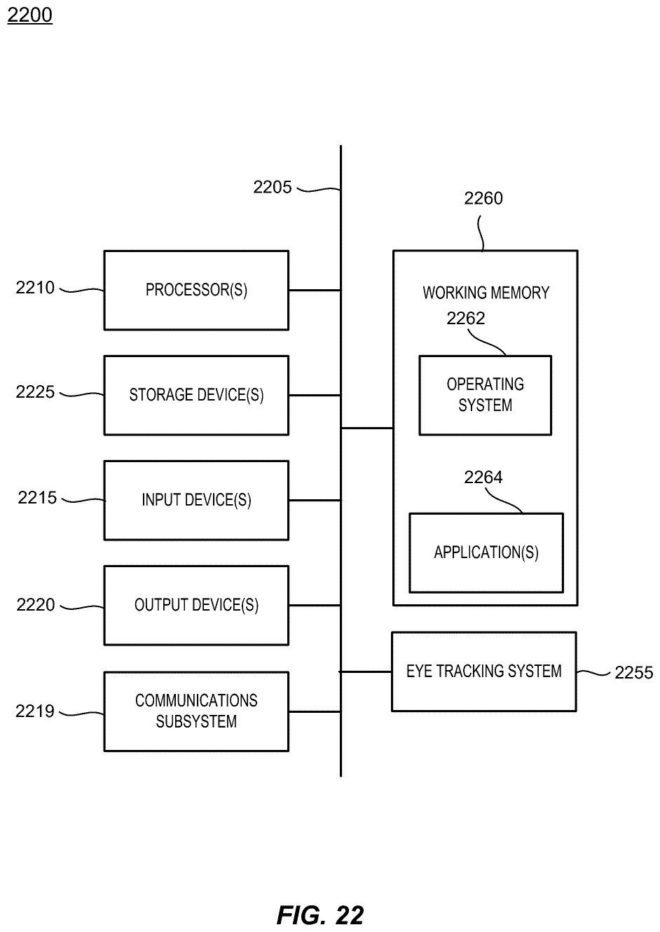

FIG. 9 is a line drawing illustrating a foveated image with three foveated regions according to an embodiment of the present invention. The image in FIG. 9 is divided into multiple regions based on the eye gaze location. In this case, the user is gazing at the center of the image resulting in the eye gaze location being located at the center of the image. As discussed herein, the eye gaze location can be determined using an eye tracking system as discussed in relation to FIGS. 5 and 22. Accordingly, the image can be divided into a central region corresponding to the eye gaze location and peripheral regions that are more distant from the eye gaze location. In some embodiments, a foveation map is created based on the eye gaze location, with portions of the image close to the eye gaze location mapping to high quality settings and portions of the image more distant from the eye gaze location mapping to lower quality settings. In FIG. 9, the foveation map takes the form of two peripheral regions with a lower quality setting and a central region with a higher (e.g., 100%) quality setting.

In the image illustrated in FIG. 9, region 910, corresponding to the left quarter of the image (i.e., the left ¼), has been compressed using a first quality setting. Additionally, region 930, corresponding to the right quarter of the image (i.e., the right ¼), has been compressed using the first quality setting. However, region 920, corresponding to the middle half of the image (i.e., the center 2/4), has been compressed using a second quality setting higher than the first quality setting. This division of the image into portions can be referred to as a tri-region division: left quarter (e.g., foveated at 70% quality setting), center half (e.g., un-foveated at 100% quality setting), and right quarter (e.g., foveated at 70% quality setting).

Although FIG. 9 illustrates division into three regions with a foveation map including these three regions, the present invention is not limited to this implementation and the image can be divided in other manners. By dividing the image into multiple regions, the quality setting for individual blocks or tiles (e.g., 8×8 pixel blocks for JPEG compression) included in each region can be set at a predetermined quality setting for each block. Thus, in FIG. 9, all of the blocks in each region are assigned the same quality setting, i.e., the blocks in region 910 are assigned a first quality setting (e.g., 70%), the blocks in region 920 are assigned a second quality setting (e.g., 100%), and the blocks in region 930 are assigned the first quality setting (e.g., 70%), but this is not required and the individual blocks in a region can be assigned different quality settings. Thus, the foveation map can be more complex than the three region division illustrated in FIG. 9. In some embodiments, a foveation map in which blocks in the peripheral regions are assigned quality settings that depend on the distance of the block from the eye gaze location while blocks in the central region have a uniform quality setting. In other embodiments, the foveation map can be defined such that blocks in the peripheral regions are assigned a uniform quality setting while blocks in the central region are assigned quality settings that depend on the distance of the block from the eye gaze location. One of ordinary skill in the art would recognize many variations, modifications, and alternatives.

In the tri-region foveated image illustrated in FIG. 9, a ˜67% overall reduction of image/memory size was achieved while retaining 100% quality in region 920, i.e., the un-foveated section. As discussed above, the region that is unfoveated (i.e., uncompressed or compressed using a lossless compression algorithm) can be any region as identified in the foveation map. As a result, the tri-region divisional illustrated in FIG. 9 is merely exemplary.

It should be noted that if the eye gaze location was, for example, on the right side of the image, the foveation map could compress the right side using a higher quality setting and the left side of the image using a lower quality setting. Thus, in this example, if the eye gaze location was within region 930, region 910 and region 920 would be compressed using a first quality setting and region 930 would be compressed using a second quality setting higher than the first quality setting. In some embodiments, for example, if the eye gaze location was within region 930, region 930 could be compressed using a higher quality setting, for instance, a lossless compression, region 920 could be compressed with an intermediate quality setting lower than the higher quality setting, and region 910 could be compressed using a lowest quality setting lower than the intermediate quality setting. As a result, the foveation of the image is a function of the eye gaze location, compressing or encoding the region including the eye gaze location with a higher quality setting than one or more regions more distant from the eye gaze location. One of ordinary skill in the art would recognize many variations, modifications, and alternatives.

Moreover, although a set of vertical regions is illustrated in FIG. 9, this is not required by embodiments of the present invention and the definition of the regions can be performed in other manners, including horizontally oriented regions, regions defined based on distance to the eye gaze location, for example, a radially-defined set of regions, or the like.

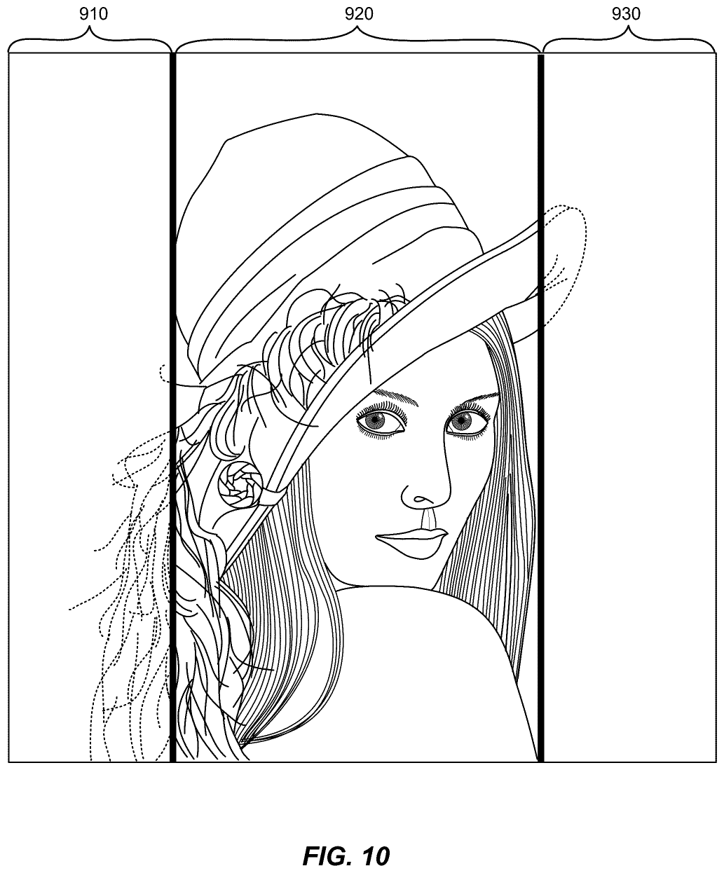

FIG. 10 is a second foveated image with post-processing in the foveated regions according to another embodiment of the present invention. After post-processing of the image illustrated in FIG. 9, the blurring of the image content in the foveated regions, i.e., region 910 and region 930, reduces the artifacts present in these regions.

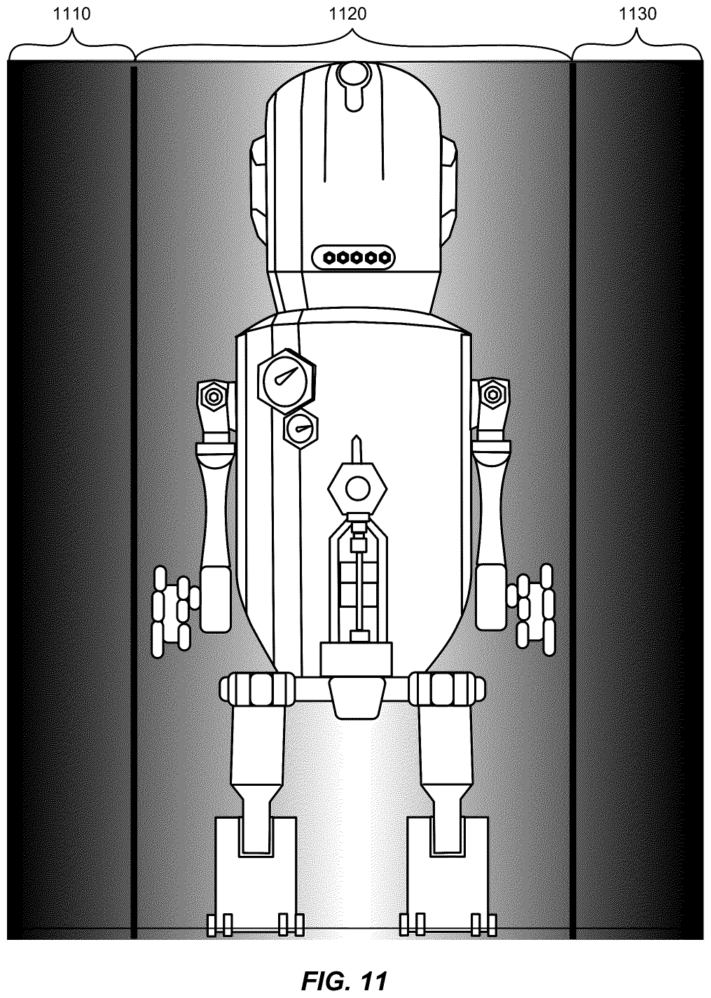

FIG. 11 is a foveated 3D generated image with three foveated regions according to yet another embodiment of the present invention. In FIG. 11, the regions are defined in a manner similar to that illustrated in FIGS. 9 and 10. However, the compression can be much higher since, for the 3D generated image, large portions of the image are black. Using the methods described herein, 87% compression was achieved while maintaining 100% quality in the center of the image corresponding to the eye gaze location. In this example, region 1120 was compressed using a 100% quality setting (un-foveated at 100% quality setting) while region 1110 and region 1130 were compressed at lower quality settings (foveated at 20% quality setting). Since, for many instances of virtual content, the image content is highest near the eye gaze location and peripheral regions are dark or black, embodiments of the present invention are particularly well suited for use with virtual reality and augmented reality implementations.

In some examples, all regions of the image can be compressed using the lower quality settings and the unfoveated region compressed with the higher quality setting. Using the example of FIG. 9, regions 910, 920, and 930 can each be compressed using the low quality setting of the foveated regions. The region 920 can also be compressed using the high quality setting. When decoding the compressed image (e.g., for reconstruction for display to a user), it may be desirable to decode the sections of the image in parallel. Therefore, two decoders can be used to decode the compressed image. During reconstruction of the image, the decoded region 920 using the high quality settings can be overlaid on the decoded regions 910, 920, 930 (i.e., the entire image) using the low quality settings. The encoding may be JPEG (e.g., using the quality settings described above) or may be techniques including DSC or VDC-X (e.g., using compression ratios) discussed more fully herein.

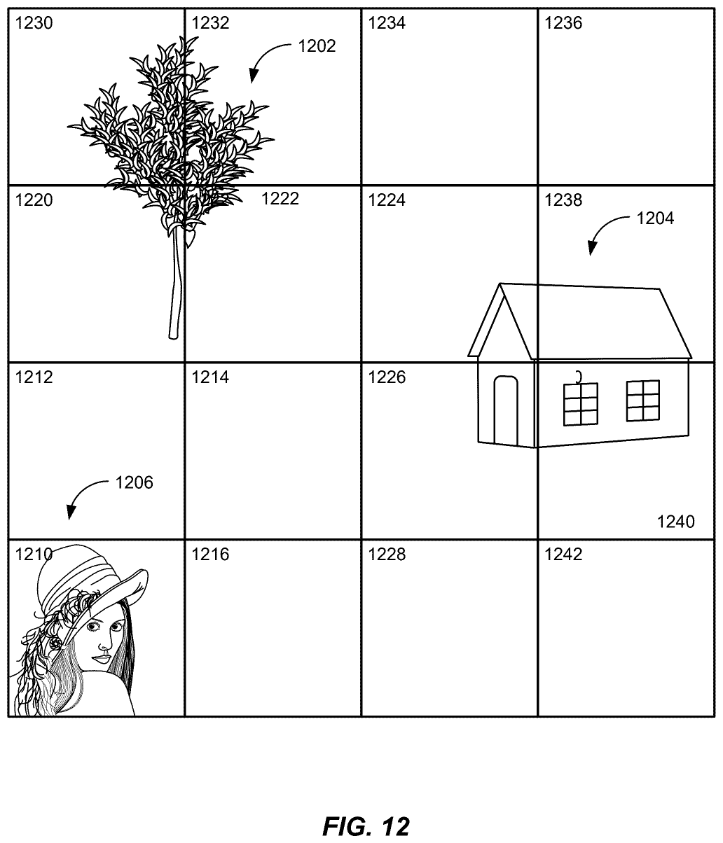

FIG. 12 is a line drawing illustrating an image that can be utilized in conjunction with multiple foveation maps according to an embodiment of the present invention. In FIG. 12, an image is represented that includes a person 1206 located in section 1210, a tree 1202 located in sections 1220, 1222, 1230, 1232, and a house 1204 located in sections 1224, 1226, 1238, and 1240. Depending on the eye gaze location, different foveation maps can be created based on this image.

If the user eye gaze location is positioned in one of sections 1220, 1222, 1230, or 1232, i.e., the user is looking at the tree 1202, then a foveation map can be utilized in which the blocks in sections 1220, 1222, 1230, and 1232 are compressed using a 100% quality setting (un-foveated at 100% quality setting) while the blocks in the remaining sections (i.e., sections 1210, 1212, 1214, 1216, 1224, 1226, 1228, 1234, 1236, 1238, 1240, and 1242 are compressed using a lower quality settings (foveated at 70% quality setting). Accordingly, compression of the image can be implemented using a foveation map that maintains the quality in the region of the image corresponding to the eye gaze location and peripheral portions of the image can be compressed using a lower quality setting to save system resources including memory and processing.

Alternatively, if the user eye gaze location is in one of sections 1224, 1226, 1238, or 1240, i.e., the user is looking at the house 1204, then a foveation map can be utilized in which the blocks in sections 1224, 1226, 1238, and 1240 are compressed using a 100% quality setting (un-foveated at 100% quality setting) while the blocks in the remaining sections (i.e., sections 1210, 1212, 1214, 1216, 1220, 1222, 1228, 1230, 1232, 1234, and 1236, and 1242 are compressed using a lower quality settings (foveated at 70% quality setting).

Finally, if the user eye gaze location is in section 1210, i.e., the user is looking at the person 1206, then a foveation map can be utilized in which the blocks in section 1210 are compressed using a 100% quality setting (un-foveated at 100% quality setting) while the blocks in the remaining sections (i.e., sections 1212, 1214, 1216, 1220, 1222, 1224, 1226, 1228, 1230, 1232, 1234, and 1236, 1238, 1240, and 1242 are compressed using a lower quality settings (foveated at 70% quality setting). In some embodiments, the quality settings used for the remaining sections are varied, for example, as a function of distance from the eye gaze location. In these embodiments, blocks in sections 1212, 1214, and 1216 could be compressed using a quality setting of 90%, blocks in sections 1220, 1222, 1224, 1226, and 1228 could be compressed using a quality setting of 80%, and blocks in sections 1230, 1232, 1234, and 1236, 1238, 1240, and 1242 could be compressed using a quality setting of 70%. In some examples, instead of encoding with JPEG (e.g., using the quality settings described above), the sections 1210-1242 may be compressed using techniques including DSC or VDC-X (e.g., using compression ratios). For example, based on the eye gaze location, a non-tile based compression technique like DSC can be used to compress the sections in proximity to the eye gaze location at a lower compression ratio while compressing the sections far from the eye gaze location at a higher compression ratio.

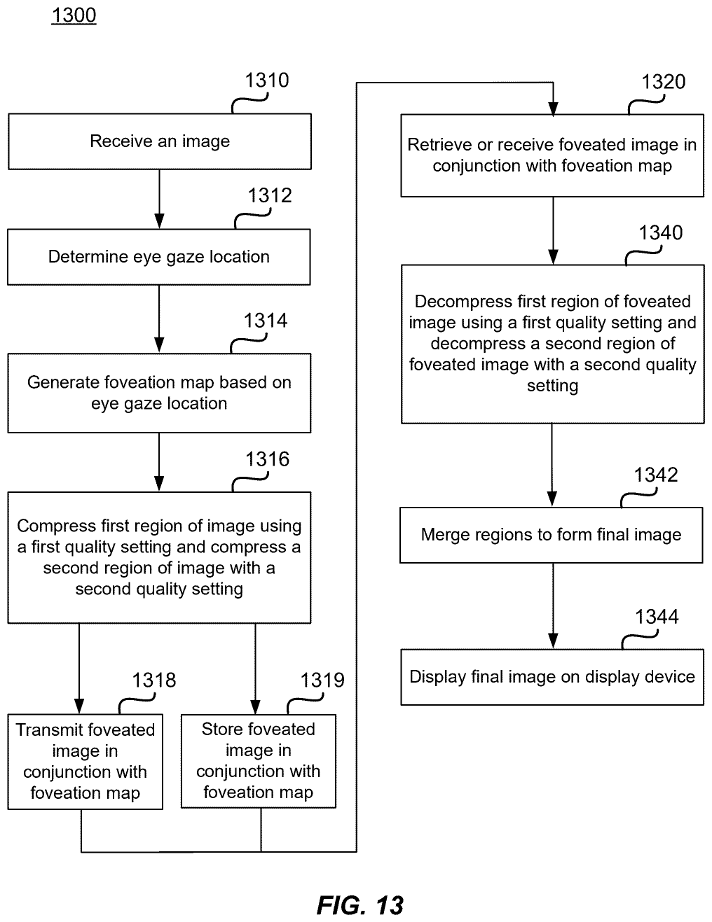

FIG. 13 is a simplified flowchart illustrating a method of compressing an image according to an embodiment of the present invention. The method 1300 includes receiving an image (1310), determining an eye gaze location of a user (1312), and generating a fovcation map based on the eye gaze location (1314).

The image may be an image included in a video stream. Determining the eye gaze location of the user can utilize an eye tracking system that provides the eye gaze location as a function of time. The foveation map defines the quality with which blocks are compressed and varies as a function of position in the image, with blocks in region(s) close to the eye gaze location being compressed using a higher quality setting and blocks in region(s) more distant from the eye gaze location being compressed using a lower quality setting. In the example illustrated in FIG. 9, three regions are included in the foveation map, but the present invention is not limited to this particular implementation and two regions or more than three regions can be defined. Moreover, the blocks in a given region can be compressed using a uniform quality setting or can be compressed with different quality settings depending on the particular implementation. In some embodiments, the foveation map includes a first region of the image and a second region of the image.

The method also includes compressing the first region of the image using a first quality setting and the second region of the image using a second quality setting (1316). In some embodiments, the first quality setting is an uncompressed quality setting or lossless compression quality setting. Thus, the blocks in the first region are compressed with higher quality than other portions of the image. The second quality setting is a lower quality setting, for example, a 70% quality setting that reduces the data corresponding to the compressed image in these regions. As discussed above, since the user's eye gaze results in these regions being in the peripheral vision of the user, any loss in quality is offset by the savings in memory and processor usage. The data compression processes for the first region and the second region can be performed sequentially or in parallel, depending on the particular application.

The compressed image or video, which can be referred to as a foveated image or video, can be transmitted to a display system, along with the foveation map (1318), or can be stored in memory, along with the foveation map (1319).

In embodiments in which the compressed image or video, along with the foveation map, is stored in memory, the method 1300 includes retrieving the foveated image and the foveation map from memory (1320) and decompressing the first region of the image using the first quality setting and the second region of the image using the second quality setting (1340). In embodiments in which the compressed image or video, along with the foveation map, is transmitted to a display system, the method 1300 includes receiving the foveated image and the foveation map (1320) and decompressing the first region of the image using the first quality setting and the second region of the image using the second quality setting (1340). The decompression processes for the first region and the second region can be performed sequentially or in parallel, depending on the particular application. The two regions can be merged to form the final image suitable for display (1342). The final image is then displayed on the display device (1344).

It should be appreciated that the specific steps illustrated in FIG. 13 provide a particular method of compressing an image according to an embodiment of the present invention. Other sequences of steps may also be performed according to alternative embodiments. For example, alternative embodiments of the present invention may perform the steps outlined above in a different order. Moreover, the individual steps illustrated in FIG. 13 may include multiple sub-steps that may be performed in various sequences as appropriate to the individual step. Furthermore, additional steps may be added or removed depending on the particular applications. One of ordinary skill in the art would recognize many variations, modifications, and alternatives.

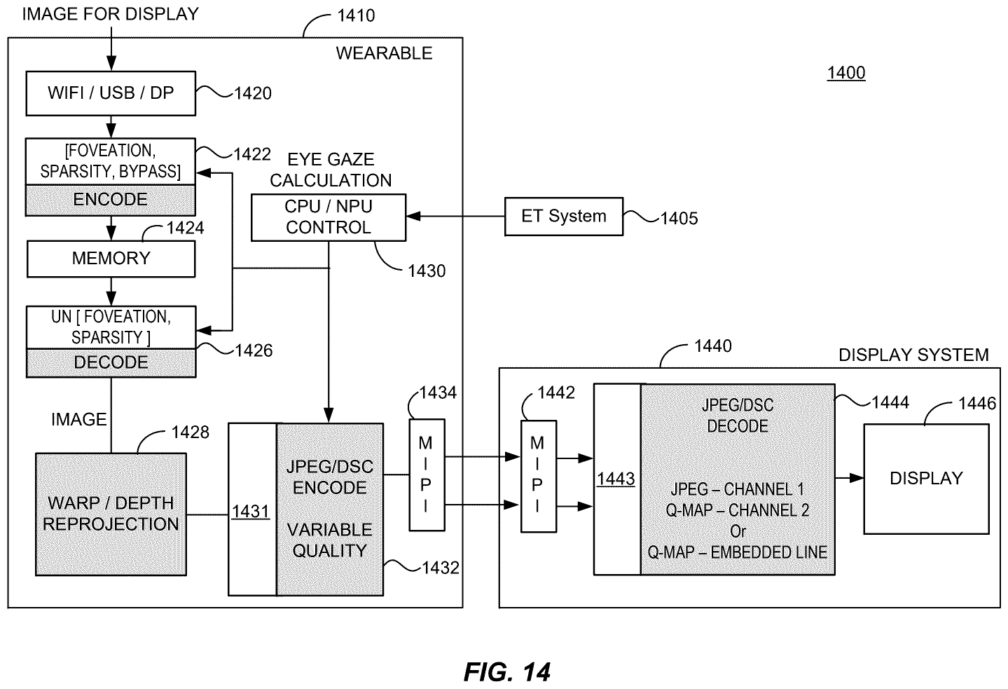

FIG. 14 is a simplified schematic diagram illustrating a gaze-based image foveation system according to an embodiment of the present invention. Referring to FIG. 14, the gaze-based image foveation system 1400 includes a wearable 1410 (e.g., a wearable including an ASIC that performs the illustrated operations) that receives an image or a video suitable for display to a user. The image or video can be received using one or more communication interfaces 1420. In the illustrated embodiment, WiFi, USB, DisplayPort (DP) or other communication protocols are utilized to receive the image or video content. In this embodiment, the uncompressed content is MPEG video.

The wearable 1410 also receives eye gaze information from an eye tracking system 1405. The eye tracking system 1405 can include one or more sensors suitable for measuring eye position and orientation and can provide data that can be utilized by eye gaze processor 1430 in calculating the user's eye gaze. In the embodiment illustrated in FIG. 14, the eye gaze processor 1430 is implemented using a CPU or neural processing unit (NPU) controller, although other processors can be utilized. One of ordinary skill in the art would recognize many variations, modifications, and alternatives.

As shown in FIG. 14, the image or video is passed to image compression processor 1422 in some embodiments, which implements a process to form a compressed image/video (e.g., a foveated image/video) based on the user's eye gaze as discussed more fully herein. Different foveation processes can be utilized as appropriate to the particular application, including tile-based foveation processes such as JPEG or DSC foveation processes as discussed more fully herein, sparsity-based compression processes, or the like. In some embodiments, image compression processor 1422 is bypassed, for example, if the image was remoted compressed before being received by one or more communication interfaces 1420, and the image or video is passed to memory 1424 for storage.

When the image or video, either compressed using image compression processor 1422 or compressed remotely, is retrieved from memory 1424, an image decompression process can be performed using decompression processor 1426 and the eye gaze information provided by eye gaze processor 1430. In embodiments in which the image was compressed remotely and image compression processor 1422 was bypassed, the decompression processor 1426 can decode the compressed image. The original or reconstructed image is then passed to warp/depth reprojection processor 1428.

After warp or depth reprojection, data provided by the eye gaze processor 1430 can be utilized once again to compress the warped image using variable quality encoder 1432 including processor component 1431 that represents image foveation based on eye gaze location. Different foveation processes can be utilized as appropriate to the particular application, including tile-based foveation processes, sparsity-based compression processes, or the like. In some embodiments, variable quality encoder 1432 including processor component 1431 is bypassed. As discussed above, a JPEG encoding process can be performed by variable quality encoder 1432 to form foveated images based on eye gaze in which the quality of the image varies across the image, providing high quality in the region of the image corresponding to the user's eye gaze and reduced quality in regions of the image more distant from the eye gaze location. Thus, foveated, as well as sparsity encoded images can be formed with reduced size while maintaining desired image quality. The encoded image is then provided to a mobile interface processor interface (MIPI) device 1434 for subsequent transmission to the display system.

The MIPI device 1434 of wearable 1410 can be connected to MIPI device 1442 of a display system 1440 that includes a variable quality decoder 1444 including a processor component 1443 that performs defoveation based on eye gaze location and a display device 1446, for example, an LCOS display or a micro-light emitting diode (uLED) display. As shown in the implementation of the variable quality decoder 1444 illustrated in FIG. 14, the JPEG/DSC tile-based encoded data or the N-way compression based encoded data (e.g., N-way DSC) can be received in a first communications channel and the quality map (Q-map), e.g., the foveation map, can be received in a second communications channel for use during the decoding process. Alternatively, the Q-map can be received using an embedded line format or other suitable format.

As illustrated in FIG. 14, the JPEG decoding process can be performed by variable quality decoder 1444 including a processor component 1443 to form final images based on the foveated images produced by variable quality encoder 1432 including a processor component 1431. Thus, embodiments of the present invention reduce system memory and transmission requirements, for example, the amount of data transmitted between the MIPI devices while maintaining desired image quality. The decoded image is then displayed using display device 1446.

In some embodiments, variable quality encoder 1432 is bypassed and the warped image is transmitted to the display system 1440 using MIPI device 1434 without variable quality image compression. In these embodiments, the variable quality decoder 1444 is also bypassed.

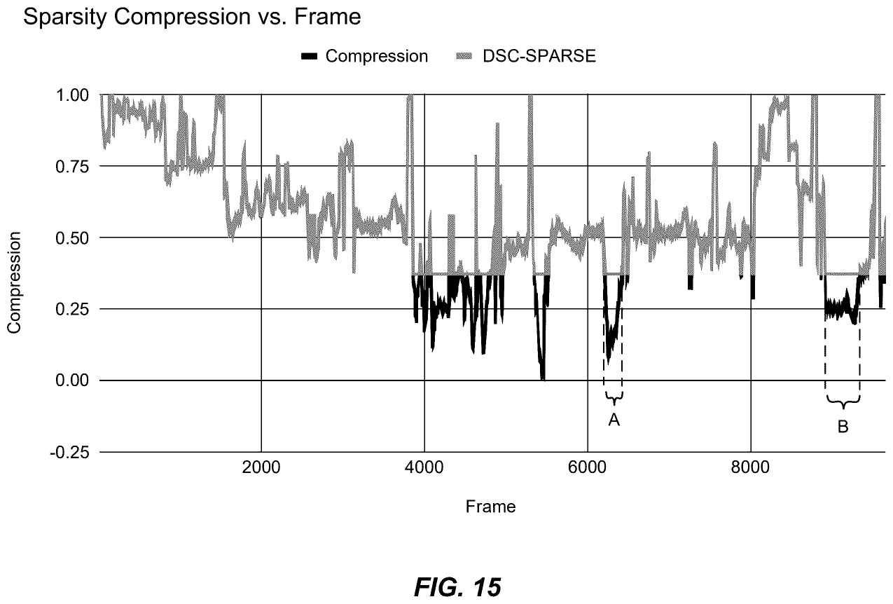

Although a tile-based (also referred to as a block-based) JPEG compression algorithm is utilized in the embodiments illustrated above, embodiments of the present invention are not limited to this particular compression standard and other compression standards can be utilized in conjunction with various embodiments of the present invention. As an example, FIGS. 15-21 describe techniques using run length encoding in conjunction with DSC and VDC-X to compress video data.

FIG. 15 illustrates a compression-level obtained as a function of time, represented by successive frames versus frequency, for both a sparsity compression system implementation and a DSC-SPARSE system implementation, according to an embodiment of the present invention. In FIG. 15, each frame was compressed using either the mask-based compression method or DSC in accordance with the alternating algorithm that implements either the mask-based compression method or the complete frame fixed compression, for example, DSC.

As shown in FIG. 15, each frame is analyzed and the number of lines having pixels characterized by a brightness level less than a threshold is determined. If the mask-based compression approach will result in a compression level greater than a compression threshold (e.g., 37%), then the frame is compressed using the mask-based compression method. In FIG. 15, this results in the first ˜3800 frames being compressed using the mask-based compression method.

If the mask-based compression method will produce a compressed frame with a compression level less than 37%, for example, a frame with very little black content, then the DSC method is utilized. This results in these frames having a 37% compression value. Referring to FIG. 15, the frames represented by blue compression values less than 37% are compressed using DSC, effectively baselining the minimum compression at 37%. Thus, the frames in sets A and B have a compression value of 37% instead of the lower value that would have been achieved using the mask-based compression method.

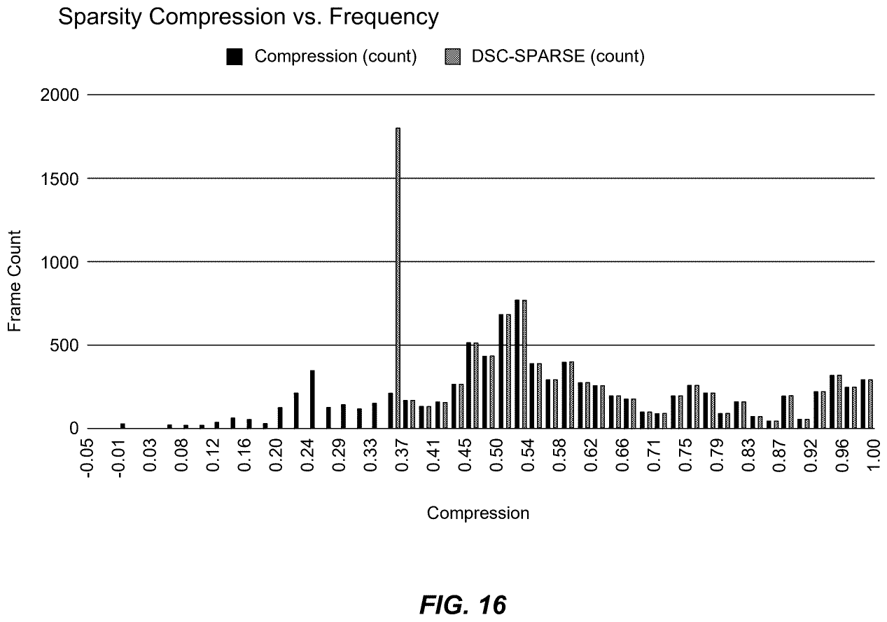

FIG. 16 illustrates a histogram of frame count versus compression for a sparsity compression system implementation and a DSC-SPARSE system implementation according to an embodiment of the present invention. As illustrated in FIG. 16, the number of frames with compression less than ˜37% is reduced to zero since either the mask-based compression method was utilized for frames that could be compressed with a compression level greater than 37% or the frame-based compression method (e.g., DSC) was utilized for the remaining frames that could not be compressed with a compression level greater than 37% using the mask-based compression method. Thus, whereas the mask-based compression method operating alone produced a number of frames with a compression level less than 37%, the alternating method provided by embodiments of the present invention limits the lowest compression level to ˜37% as illustrated in FIG. 16. For frames with significant black pixel content, the mask-based compression method provides high levels of compression while for frames with limited black pixel content, the frame-based compression method establishes a floor for the compression level, for example, 37% in this illustrated embodiment. As will be evident to one of skill in the art, the minimum compression level does not need to be 37%, which is merely exemplary and other minimum compression levels can be utilized depending on the particular application. One of ordinary skill in the art would recognize many variations, modifications, and alternatives.

The information on the compression method utilized for each frame can be provided to the endpoint, for example, a decoder or a display in order for the endpoint to utilize the appropriate decompression method when reconstructing each frame.

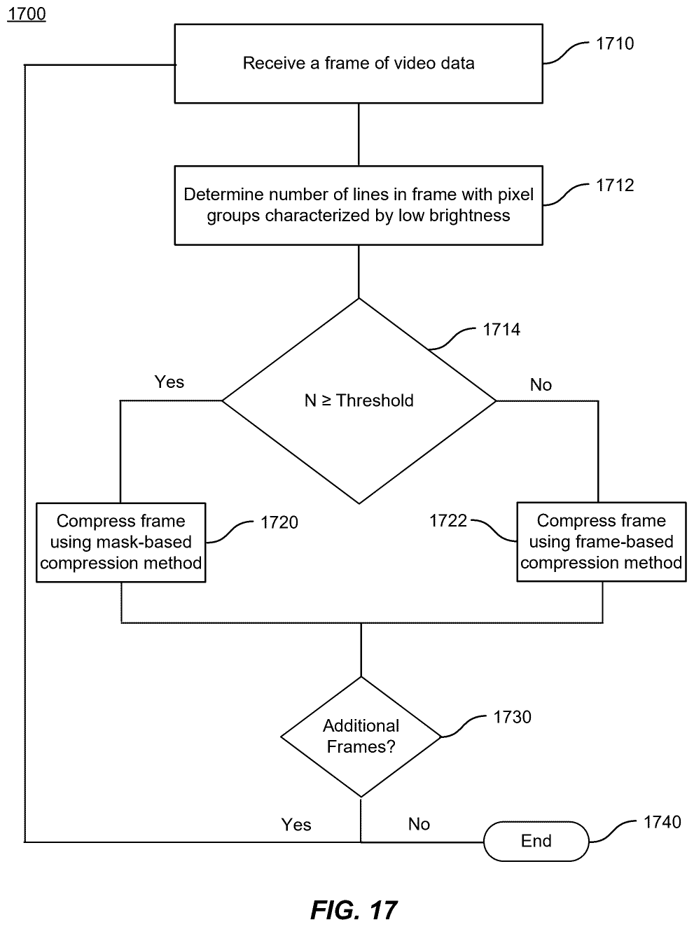

FIG. 17 is a simplified flowchart illustrating a method of compressing image frames using an alternating compression algorithm according to an embodiment of the present invention. The method 1700 includes receiving a frame of video data (1710). The method also includes determining a number of lines in the frame having pixel groups characterized by a brightness level less than a threshold (1712).

If the number of lines is greater than or equal to a compression threshold (1714), then the frame is compressed using a mask-based compression method (1720). If the number of lines is less than the compression threshold, then the frame is compressed using a frame-based compression method (1722). If additional frames are present (1730), then the method operates on the next frame of video data by receiving a frame of video data (1710). Otherwise, the method ends (1740). Accordingly, embodiments of the present invention alternate between compression methods for each frame depending on the level of compression that can be achieved by each compression method.

It should be appreciated that the specific steps illustrated in FIG. 17 provide a particular method of compressing image frames using an alternating compression algorithm according to an embodiment of the present invention. Other sequences of steps may also be performed according to alternative embodiments. For example, alternative embodiments of the present invention may perform the steps outlined above in a different order. Moreover, the individual steps illustrated in FIG. 17 may include multiple sub-steps that may be performed in various sequences as appropriate to the individual step. Furthermore, additional steps may be added or removed depending on the particular applications. One of ordinary skill in the art would recognize many variations, modifications, and alternatives.

According to some embodiments of the present invention, there would be an embedded image-line control or alternate control mechanism that, per frame, would provide information to the endpoint display related to which system to use to decode the incoming MIPI frame. In addition, virtual MIPI channels could be utilized to indicate the compression ratio used by the endpoint display.

Some embodiments of the present invention alter the compression quality based on eye tracking, thus giving the foveated regions a higher compression ratio at a loss of quality. It does this for the MIPI interface, thereby decreasing the amount of data that is sent over MIPI to the LCOS/uLED display. Thereby, embodiments also produce a saving in power consumption.

Embodiments of the present invention reduce the amount of stream-based data sent over MIPI compression that occurs. Moreover, embodiments alter the compression quality based on eye tracking, thus giving the foveated regions a higher compression ratio at a loss of quality. Furthermore, embodiments allow for a higher compression ratio for steam-based compression techniques, and allow for quality to be preserved for the areas being observed by the user. As a result, embodiments allow for a much higher compression ratio while preserving quality.

For stream-based compression standards like DSC and VESA Display Compression (VDC-X), a low latency implementation is utilized. This low latency reaction is utilized so that the previous spatial WARP adjustments that are made are still applicable.

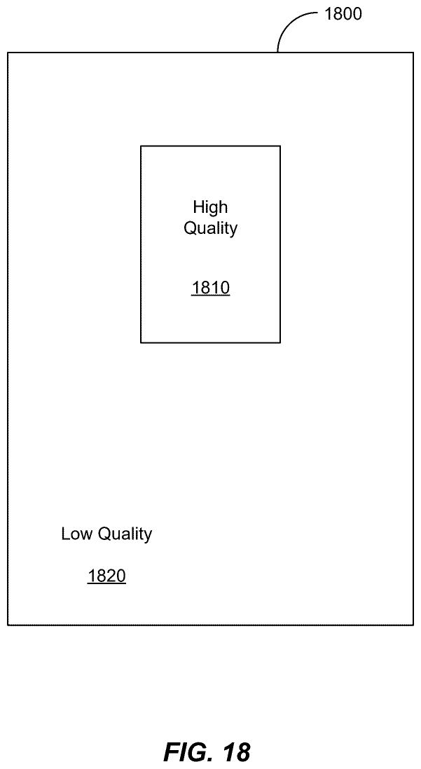

FIG. 18 is a simplified image illustrating an image frame divided into a high quality region and a low quality region according to an embodiment of the present invention. The image 1800 illustrated in FIG. 18 includes a high quality region 1810 and a low quality region 1820. As discussed more fully below, the high quality region 1810 will be compressed and decompressed using a first quality setting or compression level and the low quality region 1820, or the entire image, will be compressed and decompressed using a second quality setting or compression level providing memory savings and other benefits. As an example, a single decoder can be utilized by not compressing the high quality region 1810 and compressing the low quality region using the single decoder. If the high quality region 1810 is small compared to the entire image, significant savings can be achieved. Additional description related to varying the size of the high quality region is provided in U.S. Provisional Patent Application No. 63/543,876, filed on Oct. 12, 2023, the disclosure of which is hereby incorporated by reference in its entirety for all purposes.

### DSC

Conventional DSC does not provide for variable quality compression. Rather, DSC takes a 24 bit color encoding and compresses it down to 15/12/10/8 bits. The higher the compression (24→8 bpp), the worse the impact to quality. As to the quality required for the section that the eye is focused upon, embodiments are able to maintain, for example, a PSNR quality setting above 60 dB as discussed above. From the use case analysis illustrated in FIG. 6, the inventors have determined that this only occurs at a 37% compression configuration (24→15 bpp). However, only the area in which the eye is currently focused on actually utilizes that compression setting. The outer foveated region (e.g., the portion of the image more distant from the eye gaze location) can afford to have a lower quality, for example, 75% compression level (24→8 bpp).

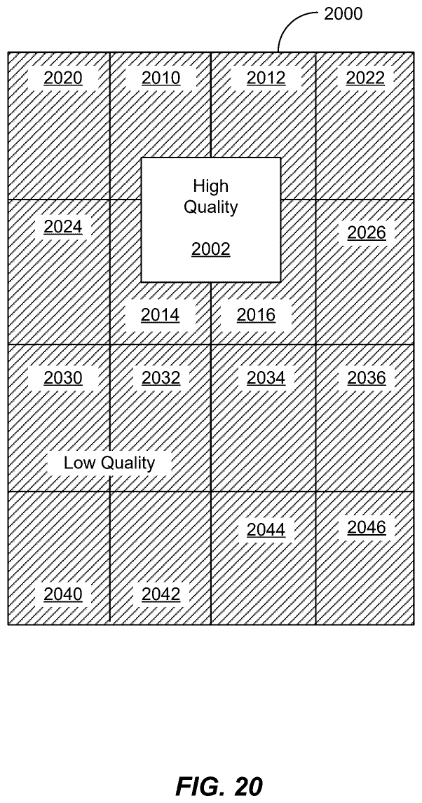

Therefore, for a neighbor-based compression standard like DSC, where there is no concept of tiles, embodiments divide the main screen into a high quality region and low quality region (as shown in FIG. 18) or smaller sections (as shown in FIG. 20), each with a different compression ratio. The selected compression ratio will be a function of the current eye gaze location. Thus, referring to FIG. 18, in which the eye gaze location is positioned inside the high quality region 1810, the high quality region 1810 can be compressed with the lower compression level (e.g., 24→15 bpp), and the low quality region 1820 can be compressed with a higher compression level (e.g., 24→8 bpp). In some examples, the low quality region 1820 can be compressed with an even higher compression level (e.g., 24→6 bpp). In embodiments in which the entire image is compressed using the higher compression level as described more fully herein, the high quality region 1810 can be overlaid on the entire image when the image is reconstructed.

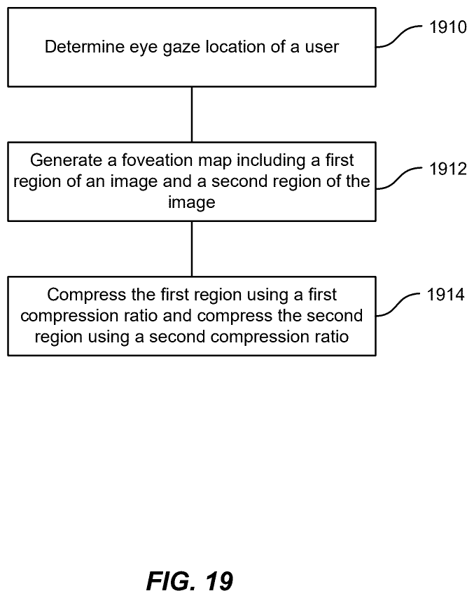

FIG. 19 is a simplified flowchart illustrating a method 1900 of compressing an image using different compression ratios for a high quality region and a low quality region, according to an embodiment of the present invention. The method 1900 includes determining an eye gaze location of a user (1910), generating a foveation map including a first region of an image and a second region of an image (1912), and compressing the first region using a first compression ratio and compressing the second region with a second compression ratio (1914).

The image may be an image included in a video stream. Determining the eye gaze location of the user can utilize an eye tracking system that provides the eye gaze location as a function of time. The foveation map defines the compression ratio with which portions of the image are compressed and varies as a function of position in the image with respect to the eye gaze location, with region(s) close to the eye gaze location being compressed using a lower compression ratio and region(s) more distant from the eye gaze location being compressed using a higher compression ratio. In the example illustrated in FIG. 18, two regions are included in the foveation map, but the present invention is not limited to this particular implementation and three regions or more than three regions can be defined. In some embodiments, the foveation map includes a first region of the image and a second region of the image. The method 1900 may be referred to as an N-way compression (e.g., DSC, VDC-X, or JPEG), where N refers to the number of regions determined for the image. For example, based on the eye gaze location, a high quality region, a medium quality region surrounding the high quality region, and a low quality region can be determined for the image. The techniques of method 1900 can then be used as a 3-way compression, with different compression ratios for each region.

Referring back to FIG. 18, in some examples the low quality region 1820 can encompass the entire image, including the portion of the image in the high quality region 1810 characterized by the eye gaze location. When decoding the compressed image (e.g., for reconstruction for display to a user), it may be desirable to decode the sections of the image in parallel. For an image divided into a high quality region 1810 and a low quality region 1820 as in FIG. 18, the low quality region 1820 may be considered as the entire image. For example, for a 2 kilopixel×2 kilopixel image (4 megapixel total), the low quality region 1820 may be the entire 4 megapixel image and may be compressed using a high compression level (e.g., 24→8 bpp). The high quality region 1810 may be determined based on the current eye gaze location and may be, for example, a 1 kilopixel by 1 kilopixel region (1 megapixel total). The high quality region 1810 can be compressed using a low compression level (e.g., 24→15 bpp). Therefore, two DSC decoders can be used to decode the compressed image. During reconstruction of the image, the decoded high quality region can be overlaid on the decoded low quality region.

FIG. 20 is a simplified image illustrating an image frame divided into high quality sections and low quality sections according to an embodiment of the present invention. As discussed more fully below, the sectioned image frame 2000 illustrated in FIG. 20 can be utilized to define a foveation map that defines the compression ratio with which different sections of the image are compressed in such a manner that the compression ratio or other compression quality metric varies as a function of position in the image with respect to the eye gaze location. As an example, sections close to the eye gaze location can be compressed using a lower compression ratio and sections that are more distant from the eye gaze location can be compressed using a higher compression ratio.

Referring to FIG. 20, the four sections 2010, 2012, 2014, and 2016 including the high quality region 2002 (i.e., the region corresponding to the current eye gaze location) will be compressed with a lower compression level (e.g., 24→15 bpp) and the remaining sections, which can be referred to as peripheral sections or low quality sections, will be compressed with a higher compression level (e.g., 24→8 bpp). As a result, when the compressed image is reconstructed for display to the user, the high quality region, which corresponds to the eye gaze location, is characterized by higher quality than the remainder of the image, which is more distant from the eye gaze location. As a result, embodiments of the present invention provide a foveated image based on the eye gaze location with reduced storage and transmission requirements.

In some embodiments of the example illustrated in FIG. 20, all sections 2010-2046 of the image may be compressed at the high compression ratio (e.g., 24→8 bpp). The four sections 2010, 2012, 2014, and 2016 including the high quality region can also be compressed with a lower compression ratio (e.g., 24→15 bpp). Using decoders, all sections 2010-2046 compressed with the high compression ratio can be decoded according to the higher compression ratio, and the four sections 2010, 2012, 2014, and 2016 compressed with the lower compression ratio can be decoded according to the lower compression ratio. During reconstruction of the image, the decoded high quality sections 2010, 2012, 2014, and 2016 can be overlaid on the decoded low quality sections 2010-2046. In some embodiments, the foveation map may define sections that are coincident with the high quality region. For example, sections 2010-2016 may include only the high quality region characterized by the eye gaze location, without including portions of the image in the low quality regions.

As with the N-way compression, it may be desirable to use multiple DSC decoders to decode the compressed image in the section-based DSC technique. For example, four DSC decoders can be used to decode the compressed image, with one decoder used to decode the high quality sections 2010-2016, another decoder used to decode the sections 2020-2026, a third decoder used to decode the sections 2030-2036, and a fourth decoder used to decode the sections 2040-2046, with each decoder using a compression ratio for each group of sections based on proximity to the eye gaze location. In some embodiments, depending on the memory capacity (e.g., SRAM) of the system used to decode, a single decoder may be implemented with acceptable latency when decoding the compressed image.

The image may be an image included in a video stream. Determining the eye gaze location of the user can utilize an eye tracking system that provides the eye gaze location as a function of time. The foveation map defines the compression ratio with which different sections (e.g., sections 2010-2016, sections 2020-2026, sections 2030-2036, and sections 2040-2046) of the image are compressed and varies as a function of position in the image with respect to the eye gaze location, with sections close to the eye gaze location being compressed using a lower compression ratio and sections more distant from the eye gaze location being compressed using a higher compression ratio. In the example illustrated in FIG. 20, 16 sections are included in the foveation map, but the present invention is not limited to this particular implementation and more or fewer than 16 sections can be defined. The methods described herein may be referred to as section-based compression (e.g., DSC, VDC-X, or JPEG) methods.

Although only two compression levels are illustrated in some of the above examples, embodiments of the present invention are not limited to these particular compression levels, but additional number of levels of compression can be utilized. For example, sections 2010-2014 could be compressed using a 37% compression level (i.e., 24→15 bpp) while sections 2020, 2022, 2024, and 2026, which are more distant from the high quality region, could be compressed using a 50% compression level (i.e., 24→15 bpp), sections 2030, 2032, 2034, and 2036, which are more distant from the high quality region than sections 2020-2026, could be compressed using a 58% compression level (i.e., 24→12 bpp), and sections 2040, 2042, 2044, and 2046, which are most distant from the high quality region than sections 2010-2016, could be compressed using a 67% compression level (i.e., 24→8 bpp). Thus, the use of two compression levels is merely exemplary. Furthermore, for some sections, the compression level may be 0%, i.e., uncompressed, including sections corresponding to the eye gaze location and high quality region. Thus, the compressed image could have uncompressed sections as well as compressed sections. One of ordinary skill in the art would recognize many variations, modifications, and alternatives.

Furthermore, although only sixteen uniform area sections are illustrated in FIG. 20, this is not required and other numbers of sections, including sections with differing sizes can be utilized, with smaller sections adjacent the high quality region and larger sections, for example, sections compressed at higher levels, at greater distances from the high quality region. Thus, the number of compression levels, the levels of compression, the number of the sections, and the sizes of the sections can be varied as appropriate to the particular application. One of ordinary skill in the art would recognize many variations, modifications, and alternatives.

As the frame size is decreased as a result of the compression of the image, the communication interface, e.g., the MIPI interface, can be modified to enter a low-power data transmission mode or even enter an ultra-low-power sleep mode, thereby saving compute resources and reducing power consumption. At the end point, reconstruction of the compressed image can be performed prior to display to the user.

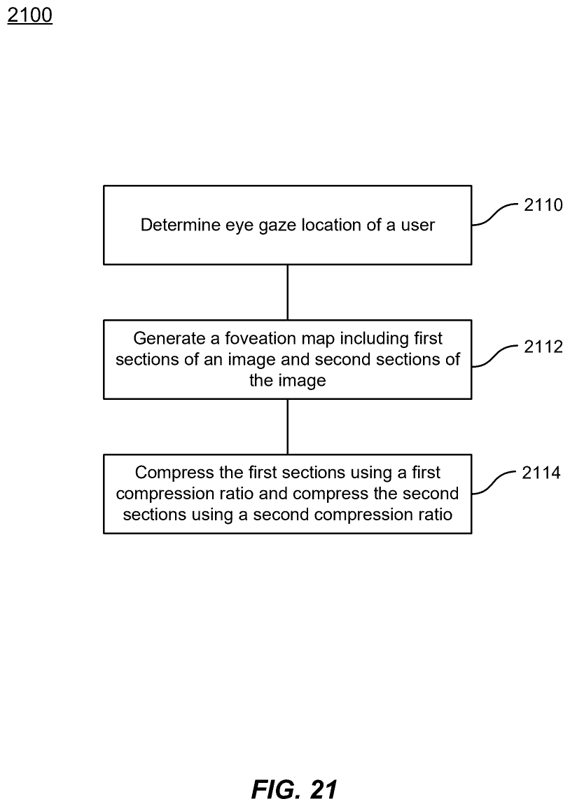

FIG. 21 is a simplified flowchart illustrating a method 2100 of compressing an image using different compression ratios for high quality sections and low quality sections, according to an embodiment of the present invention. The method 2100 includes determining an eye gaze location of a user (2110), generating a foveation map including first sections of an image and second sections of an image (2112), and compressing the first region using a first compression ratio and compressing the second region with a second compression ratio (2114).

It should be appreciated that the specific steps illustrated in FIGS. 19 and 21 provide particular methods of compressing an image according to an embodiment of the present invention. Other sequences of steps may also be performed according to alternative embodiments. For example, alternative embodiments of the present invention may perform the steps outlined above in a different order. Moreover, the individual steps illustrated in FIGS. 19 and 21 may include multiple sub-steps that may be performed in various sequences as appropriate to the individual step. Furthermore, additional steps may be added or removed depending on the particular applications. One of ordinary skill in the art would recognize many variations, modifications, and alternatives.

### VDC-X

The VDC-X compression standard (e.g., VDC-M) uses a tile-based approach instead of a nearest neighbor approach. This compression standard encodes different tiles at different quality settings, however the goal of this conventional compression is to maintain an overall constant frame size (i.e., bit rate). So once a compression ratio is selected, it varies each tile in order to maintain the constant bit rate. Using this compression standard in conjunction with embodiments of the present invention, video images are compressed, not solely based on bit rate, but based on the user's eye gaze location. As an example, the four sections 2010, 2012, 2014, and 2016 including the high quality region (i.e., the region corresponding to the current eye gaze location) will be compressed with a higher quality setting than the remaining sections, which can be referred to as peripheral sections, which will be compressed with a lower quality setting that that used for the sections 2010-2016.

Some embodiments of the present invention do not maintain a constant bit rate, so that each frame size varies over time, and that the transport interface, for example, MIPI, is put into a low power mode when not in use.

In a manner similar to the DSC-based approach discussed above, for a VDC-X tile-based approach, embodiments encode the quality of each tile based on the current location of the user's eye-gaze. As illustrated in FIG. 20, using the eye gaze information provided by the eye gaze tracking system of the AR system, tiles are compressed using the VDC-X standard as a function of the distance of the tile from the eye gaze location.

Therefore, embodiments of the present invention are able to vary the frame size or bit rate per frame, and to use the current eye-gaze information in order to select which tile (VDC-X) or section (DSC) has a higher quality vs the foveated regions that have a lower quality setting.

In some embodiments, the N-way compression or the section-based compression described above can implement JPEG as the compression standard rather than DSC or VDC-X. In these embodiments, the compression ratios used for the high quality/low quality regions and/or the high quality/low quality sections can instead refer to the quality settings of the JPEG standard.

FIG. 22 is a simplified block diagram illustrating components of an AR system according to an embodiment of the present invention. AR system 2200 as illustrated in FIG. 22 may be incorporated into the AR devices as described herein. FIG. 22 provides a schematic illustration of one embodiment of AR system 2200 that can perform some or all of the steps of the methods provided by various embodiments. It should be noted that FIG. 22 is meant only to provide a generalized illustration of various components, any or all of which may be utilized as appropriate. FIG. 22, therefore, broadly illustrates how individual system elements may be implemented in a relatively separated or relatively more integrated manner.

AR system 2200 is shown comprising hardware elements that can be electrically coupled via a bus 2205, or may otherwise be in communication, as appropriate. The hardware elements may include one or more processors 2210, including without limitation one or more general-purpose processors and/or one or more special-purpose processors such as digital signal processing chips, graphics acceleration processors, and/or the like; one or more input devices 2215, which can include, without limitation, a mouse, a keyboard, a camera, and/or the like; and one or more output devices 2220, which can include, without limitation, a display device, a printer, and/or the like. Additionally, AR system 2200 includes an eye tracking system 2255 that can provide the user's eye gaze location to the AR system. Utilizing processor 2210, the foveated image compression techniques discussed herein can be implemented.

AR system 2200 may further include and/or be in communication with one or more non-transitory storage devices 2225, which can comprise, without limitation, local and/or network accessible storage, and/or can include, without limitation, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

AR system 2200 might also include a communications subsystem 2219, which can include, without limitation, a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. Communications subsystem 2219 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via communications subsystem 2219. In other embodiments, a portable electronic device, e.g., the first electronic device, may be incorporated into AR system 2200, e.g., an electronic device as an input device 2215. In some embodiments, AR system 2200 will further comprise a working memory 2260, which can include a RAM or ROM device, as described above.

AR system 2200 also can include software elements, shown as being currently located within working memory 2260, including an operating system 2262, device drivers, executable libraries, and/or other code, such as one or more application programs 2264, which may comprise computer programs provided by various embodiments, and/or may be designed to implement methods, and/or configure systems, provided by other embodiments, as described herein. Merely by way of example, one or more procedures described with respect to the methods discussed above might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as storage device(s) 2225 described above. In some cases, the storage medium might be incorporated within a computer system, such as AR system 2200. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by AR system 2200 and/or might take the form of source and/or installable code, which, upon compilation and/or installation on AR system 2200, e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as AR system 2200 to perform methods in accordance with various embodiments of the technology. According to a set of embodiments, some or all of the procedures of such methods are performed by AR system 2200 in response to processor 2210 executing one or more sequences of one or more instructions, which might be incorporated into operating system 2262 and/or other code, such as an application program 2264, contained in working memory 2260. Such instructions may be read into working memory 2260 from another computer-readable medium, such as one or more of storage device(s) 2225. Merely by way of example, execution of the sequences of instructions contained in working memory 2260 might cause processor(s) 2210 to perform one or more procedures of the methods described herein. Additionally or alternatively, portions of the methods described herein may be executed through specialized hardware.

The terms machine-readable medium and computer-readable medium, as used herein, refer to any medium that participates in providing data that causes a machine to operate in a specific fashion. In an embodiment implemented using AR system 2200, various computer-readable media might be involved in providing instructions/code to processor(s) 2210 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as storage device(s) 2225. Volatile media include, without limitation, dynamic memory, such as working memory 2260.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to processor(s) 2210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by AR system 2200.

Communications subsystem 2219 and/or components thereof generally will receive signals, and bus 2205 then might carry the signals and/or the data, instructions, etc. carried by the signals to working memory 2260, from which processor(s) 2210 retrieves and executes the instructions. The instructions received by working memory 2260 may optionally be stored on a non-transitory storage device 2225 either before or after execution by processor(s) 2210.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a method of compressing an image, the method comprising: determining an eye gaze location of a user; generating a foveation map based on the eye gaze location, wherein the foveation map includes a first region of the image and a second region of the image; and compressing the first region of the image using a first quality setting and the second region of the image using a second quality setting.

Example 2 is the method of example 1 wherein determining the eye gaze location comprises use of an eye tracking camera of an augmented reality device.

Example 3 is the method of example(s) 1-2 wherein the foveation map includes a central region and a peripheral region.

Example 4 is the method of example(s) 1-3 wherein the image comprises virtual content generated by an augmented reality device.

Example 5 is the method of example(s) 1-4 wherein the image is included in a virtual content video stream.

Example 6 is the method of example(s) 1-5 wherein compressing the first region of the image using the first quality setting comprises compressing all blocks in the first region using the first quality setting.

Example 7 is the method of example(s) 1-6 wherein the first quality setting is greater than the second quality setting.

Example 8 is the method of example(s) 1-7 wherein the first quality setting is 100%.

Example 9 is the method of example(s) 1-8 further comprising post-processing image content in at least one of the first region or the second region.

Example 10 is the method of example(s) 1-9 wherein the compressing produces a compressed image, the method further comprising decoding the compressed image using the foveation map.

Example 11 is the method of example(s) 1-10 wherein: the first region of the image includes a plurality of first blocks; the second region of the image includes a plurality of second blocks; compressing the first region of the image comprises compressing each of the plurality of first blocks using the first quality setting; and compressing the second region of the image comprises compressing each of the plurality of second blocks using the second quality setting.

Example 12 is the method of claim example(s) 1-11 further comprising: decompressing the first region of the image using the first quality setting; decompressing the second region of the image using the second quality setting; and displaying the image to the user.

Example 13 is the method of example(s) 1-12 wherein the second region of the image includes the first region of the image.

Example 14 is the method of example(s) 1-13 wherein the compressing produces a compressed image, the method further comprising: decoding the compressed image using the foveation map to produce a decoded first region and a decoded second region; and reconstructing the image by overlaying the decoded first region over the decoded second region.

Example 15 is an augmented reality (AR) system comprising: a wearable device including: a frame; a projector coupled to the frame; a display optically coupled to the projector; and an eye tracking system; a memory; and a processor configured to: receive an eye gaze location from the eye tracking system; generate an image; generate a foveation map based on the eye gaze location, wherein the foveation map includes a first region of the image and a second region of the image; and compress the first region of the image using a first quality setting and the second region of the image using a second quality setting.

Example 16 is the AR system of example 15 wherein the projector comprises one projector of a set of projectors, the display comprises one display of a set of displays, and the eye tracking system includes a set of eye tracking devices.

Example 17 is the AR system of example(s) 15-16 wherein determining the eye gaze location comprises use of an eye tracking camera of an augmented reality device.

Example 18 is the AR system of example(s) 15-17 wherein the foveation map includes a central region and a peripheral region.

Example 19 is the AR system of example(s) 15-18 wherein the image comprises virtual content generated by an augmented reality device.

Example 20 is the AR system of example(s) 15-19 wherein the image is included in a virtual content video stream.

Example 21 is the AR system of example(s) 15-20 wherein compressing the first region of the image using the first quality setting comprises compressing all blocks in the first region using the first quality setting.

Example 22 is the AR system of example(s) 15-21 wherein the first quality setting is greater than the second quality setting.

Example 23 is the AR system of example(s) 15-22 wherein the first quality setting is 100%.

Example 24 is the AR system of example(s) 15-23 wherein the processor is further configured to post-process image content in at least one of the first region or the second region.

Example 25 is the AR system of example(s) 15-24 wherein the compressing produces a compressed image, wherein the processor is further configured to decode the compressed image using the foveation map.

Example 26 is the AR system of example(s) 15-25 wherein: the first region of the image includes a plurality of first blocks; the second region of the image includes a plurality of second blocks; compressing the first region of the image comprises compressing each of the plurality of first blocks using the first quality setting; and compressing the second region of the image comprises compressing each of the plurality of second blocks using the second quality setting.

Example 27 is the AR system of example(s) 15-26 wherein the processor is further configured to: decompress the first region of the image using the first quality setting; decompress the second region of the image using the second quality setting; and display the image to the user.

Example 28 is the AR system of example(s) 15-27 wherein the second region of the image includes the first region of the image.

Example 29 is the AR system of example(s) 15-28 wherein compressing produces a compressed image and the processor is further configured to: decode the compressed image using the foveation map to produce a decoded first region and a decoded second region; and reconstruct the image by overlaying the decoded first region over the decoded second region.

Example 30 is a non-transitory computer-readable medium comprising program code that is executable by a processor of a device that is wearable by a user, the program code being executable by the processor to: determine an eye gaze location of a user; generate a foveation map based on the eye gaze location, wherein the foveation map includes a first region of the image and a second region of the image; and compress the first region of the image using a first quality setting and the second region of the image using a second quality setting.

In the foregoing specification, the disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than restrictive sense.

Indeed, it will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example process in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Accordingly, the claims are not intended to be limited to the embodiments shown herein, but are to be accorded the widest scope consistent with this disclosure, the principles and the novel features disclosed herein. Thus, it is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of compressing an image, the method comprising:
determining an eye gaze location of a user;
generating a foveation map based on the eye gaze location, wherein the foveation map includes a first region of the image and a second region of the image; and
compressing the first region of the image using a first quality setting and the second region of the image using a second quality setting.

2. The method of claim 1 wherein determining the eye gaze location comprises use of an eye tracking camera of an augmented reality device.

3. The method of claim 1 wherein the foveation map includes a central region and a peripheral region.

4. The method of claim 1 wherein the image comprises virtual content generated by an augmented reality device.

5. The method of claim 4 wherein the image is included in a virtual content video stream.

6. The method of claim 1 wherein compressing the first region of the image using the first quality setting comprises compressing all blocks in the first region using the first quality setting.

7. The method of claim 1 wherein the first quality setting is greater than the second quality setting.

8. The method of claim 1 further comprising post-processing image content in at least one of the first region or the second region.

9. The method of claim 1 wherein the compressing produces a compressed image, the method further comprising decoding the compressed image using the foveation map.

10. The method of claim 1 wherein:
the first region of the image includes a plurality of first blocks;
the second region of the image includes a plurality of second blocks;
compressing the first region of the image comprises compressing each of the plurality of first blocks using the first quality setting; and
compressing the second region of the image comprises compressing each of the plurality of second blocks using the second quality setting.

11. The method of claim 1 further comprising:
decompressing the first region of the image using the first quality setting;
decompressing the second region of the image using the second quality setting; and
displaying the image to the user.

12. The method of claim 1 wherein the second region of the image includes the first region of the image.

13. The method of claim 12 wherein the compressing produces a compressed image, the method further comprising:
decoding the compressed image using the foveation map to produce a decoded first region and a decoded second region; and
reconstructing the image by overlaying the decoded first region over the decoded second region.

14. An augmented reality (AR) system comprising:
a wearable device including:
a frame;
a projector coupled to the frame;
a display optically coupled to the projector; and
an eye tracking system;
a memory; and
a processor configured to:
receive an eye gaze location from the eye tracking system;
generate an image;
generate a foveation map based on the eye gaze location, wherein the foveation map includes a first region of the image and a second region of the image; and
compress the first region of the image using a first quality setting and the second region of the image using a second quality setting.

15. The AR system of claim 14 wherein the projector comprises one projector of a set of projectors, the display comprises one display of a set of displays, and the eye tracking system includes a set of eye tracking devices.

16. The AR system of claim 15 wherein the wearable device further comprises an eye tracking camera.

17. The AR system of claim 15 wherein the foveation map includes a central region and a peripheral region.

18. The AR system of claim 15 wherein compressing the first region of the image using the first quality setting comprises compressing all blocks in the first region using the first quality setting, wherein the first quality setting is greater than the second quality setting.
